(19) United States
(12) Patent Application Publication
(10) Pub. No.: US 2024/0256529 A1
(43) Pub. Date: Aug. 1, 2024

(54) CONSTRAINED NATURAL LANGUAGE USER INTERFACE

(71) Applicant: DataChat.ai, Madison, WI (US)

(72) Inventors: Jignesh Patel, Madison, WI (US); Rogers Jeffrey Leo John, Middleton, WI (US); Robert Konrad Claus, Madison, WI (US); Jiatong Li, Madison, WI (US); Sulong Zhou, Madison, WI (US); Yukiko Suzuki, Fairfax, VA (US)

(21) Appl. No.: 18/160,187

(22) Filed: Jan. 26, 2023

(51) Int. Cl. G06F 16/242; G06F 3/0482; G06F 16/28

(52) U.S. Cl. CPC G06F 16/243; G06F 3/0482; G06F 16/283; G06F 2203/04803

(57) ABSTRACT

A device comprising a processor and a memory may be configured to perform the techniques described in this disclosure. The processor may present, via one or more portions of a first, second, or third user interface, one or more of either an interactive text box or interactive search bar in which a user may enter data indicative of a current input, an interactive log of previous inputs, a graphical representation of result data obtained responsive to the data indicative of the current input, one or more datasets, and at least a portion of the multi-dimensional data included in the one or more datasets. Various portions of the various user interfaces are separately scrollable but coupled such that interactions in the various portions of the various user interfaces synchronize the various portions of the various user interfaces. The memory is configured to store the data indicative of the current input.

### TECHNICAL FIELD

This disclosure relates to user interfaces for computing and data analytics systems, and more specifically, user interfaces for systems using natural language processing.

### BACKGROUND

Data analytics systems are increasingly using natural language processing to facilitate interactions by users who are unaccustomed to formal, or in other words, structured database languages. Natural language processing generally refers to a technical field in which computing devices process user inputs provided by users via conversational interactions using human languages. For example, a device may prompt a user for various inputs, present clarifying questions, present follow-up questions, or otherwise interact with the user in a conversational manner to elicit the input. The user may likewise enter the inputs as sentences or even fragments, thereby establishing a simulated dialog with the device to specify one or more intents (which may also be referred to as “tasks”) to be performed by the device.

During this process the device may generate various interfaces to present the conversation. An example interface may act as a so-called “chatbot,” which often is configured to attempt to mimic human qualities, including personalities, voices, preferences, humor, etc. in an effort to establish a more conversational tone, and thereby facilitate interactions with the user by which to more naturally receive the input. Examples of chatbots include “digital assistants” (which may also be referred to as “virtual assistants”), which are a subset of chatbots focused on a set of tasks dedicated to assistance.

However, while natural language processing may facilitate data analytics by users unaccustomed with formal database languages, the user interface associated with natural language processing, such as the chatbot, may in some instances, be cluttered and difficult to understand due to the conversational nature of natural language processing. Moreover, the conversation resulting from natural language processing may distract certain users from the underlying data analytics result, thereby possibly detracting from the benefits of natural language processing in the context of data analytics.

### SUMMARY

In general, this disclosure describes techniques for user interfaces that better facilitate user interaction with data analytic systems that employ natural language processing. Rather than present a cluttered user interface in which one or more users struggle to understand the results produced by the data analytic system, various aspects of the techniques described in this disclosure may allow for a seamless integration of natural language processing with data analytics in a manner that results in more cohesive user interfaces by which one or more users may intuitively understand the results produced by the data analytics system.

In one example, a user interface may include a “notebook view” in which interactions, tasks, conversations, etc. between the one or more users and the system are recorded. More specifically, the notebook view may provide, via a first portion of the user interface (e.g., a first frame), an interactive text box that allows one or more users to express intents via natural language. The notebook view may also include a second portion (e.g., a second frame) that presents an interactive log of previous inputs and responses from the natural language processing engine, which allows the one or more users to quickly assess how the results and/or responses were derived. The notebook view may also include a third portion (e.g., a third frame) that presents a graphical representation of the results provided responsive to any inputs.

In another example, a user interface may include a “spreadsheet view” in which the one or more users can easily load, view, manipulate, analyze, and visualize data. More specifically, the spreadsheet view may include a first portion (e.g., a first frame) that presents the interactive log of previous inputs and responses from the natural language processing engine included in the notebook view, thus enabling the one or more users to toggle between the notebook view and spreadsheet view without losing any results or historical information. The spreadsheet view may also include a second portion (e.g., a second frame) that presents the graphical representation of the results provided responsive to any inputs also included in the notebook view. The spreadsheet view may also include a third portion (e.g., a third frame) that presents one or more datasets that the one or more users can analyze or visualize. The spreadsheet view may also include a fourth portion (e.g., a fourth frame) that presents at least a portion of the multi-dimensional data included in the one or more datasets.

In another example, a user interface may include a “search view” in which the one or more users can quickly and efficiently visualize data through simple inputs that the system can interpret via natural language processing algorithms. More specifically, the search view may provide, via a first portion of the user interface (e.g., a first frame), an interactive search bar that allows one or more users to express intents via natural language. The search view may also include a second portion (e.g., a second frame) that presents an interactive log of previous inputs and responses from the natural language processing engine, which again allows the one or more users to quickly assess how the results and/or responses were derived. The search view may also include a third portion (e.g., a third frame) that presents a graphical or visual representation of the results provided responsive to any inputs. The search view may also include a fourth portion (e.g., a fourth frame) that presents the one or more datasets that the one or more users can analyze or visualize.

In each example described herein, the various portions of the various user interfaces may be separately scrollable to accommodate how different users understand different aspects of the results. Additionally, in each instance, the various portions do not overlap or otherwise obscure data that would otherwise be relevant to the one or more users at a particular point in time, thereby allowing the one or more users to better comprehend the results provided along with the historical logs presented.

In this respect, various aspect of the techniques described in this disclosure may facilitate better interactions with respect to performing data analytics while also removing clutter and other distractions that may distract from understanding results provided by data analytic systems. As a result, data analytic systems may operate more efficiently, as users are able to more quickly understand the results without having to enter additional inputs and/or perform additional interactions with the data analytic system to understand presented results. By potentially reducing such inputs and/or interactions, the data analytics system may conserve various computing resources (e.g., processing cycles, memory space, memory bandwidth, etc.) along with power consumption consumed by such computing resources, thereby improving operation of data analytic systems themselves.

As such, various aspects of the techniques described in this disclosure may help to reduce the number of interactions between the one or more users and the system that are needed to generate visual representations or perform analyses of multi-dimensional data (which may also be referred to as a “result”). Further, the data analytics system may again operate more efficiently, as users are able to more quickly understand the results without having to enter additional inputs and/or perform additional interactions with the data analytics system. Additionally, by potentially reducing such inputs and/or interactions, the data analytic system may conserve various computing resources (e.g., processing cycles, memory space, memory bandwidth, etc.) along with power consumption consumed by such computing resources, thereby improving operation of data analytic systems themselves.

The details of one or more aspects of the techniques are set forth in the accompanying drawings and the description below. Other features, objects, and advantages of these techniques will be apparent from the description and drawings, and from the claims.

### BRIEF DESCRIPTION OF DRAWINGS

FIG. 1 is a block diagram illustrating a system that may perform various aspects of the techniques described in this disclosure.

FIG. 2 is a diagram illustrating an example interface presented by the interface unit of the host device shown in FIG. 1 that includes a number of different applications executed by the execution platforms of the host device.

FIGS. 3A-3H are diagrams illustrating a notebook view interface presented by the interface unit of the host device shown in FIG. 1 that facilitates data analytics via the “Ava” application shown in FIG. 2 in accordance with various aspects of the CNLP techniques described in this disclosure.

FIGS. 4A-4M are diagrams illustrating a spreadsheet view interface presented by the interface unit of the host device shown in FIG. 1 that facilitates data analytics via the “Ava” application shown in FIG. 2 in accordance with various aspects of the CNLP techniques described in this disclosure.

FIGS. 5A-5O are diagrams illustrating a search view interface presented by the interface unit of the host device shown in FIG. 1 that facilitates data analytics via the “Ava” application shown in FIG. 2 in accordance with various aspects of the CNLP techniques described in this disclosure.

FIG. 6 is a block diagram illustrating example components of the devices shown in the example of FIG. 1.

FIG. 7 is a flowchart illustrating example operation of the system of FIG. 1 in performing various aspects of the techniques described in this disclosure to enable more cohesive user interfaces for data analytic systems.

FIG. 8 is a flowchart illustrating another example operation of the system of FIG. 1 in performing various aspects of the techniques described in this disclosure to enable more cohesive user interfaces for data analytic systems.

### DETAILED DESCRIPTION

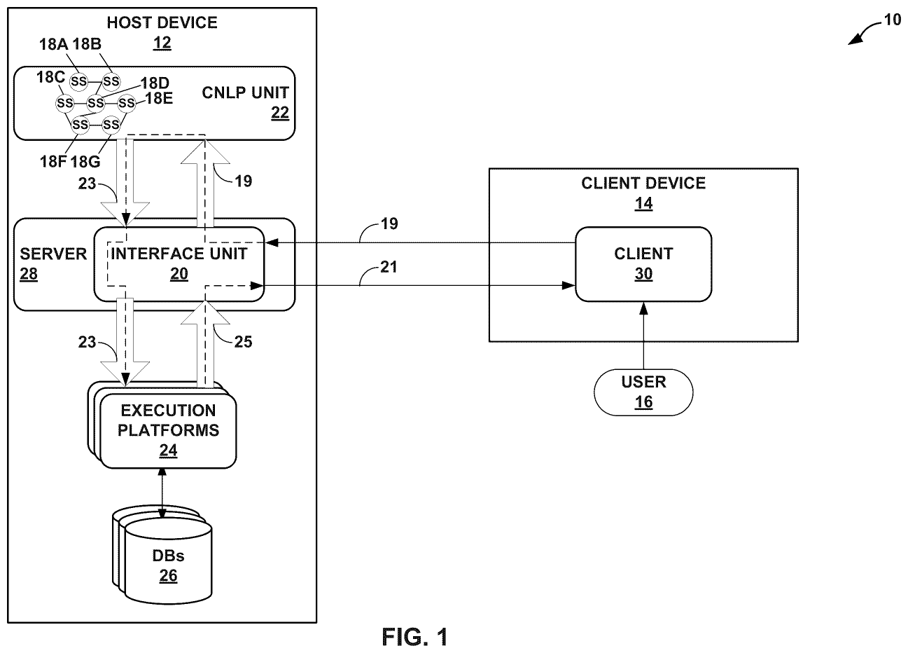

FIG. 1 is a diagram illustrating a system 10 that may perform various aspects of the techniques described in this disclosure for constrained natural language processing (CNLP). As shown in the example of FIG. 1, system 10 includes a host device 12 and a client device 14. Although shown as including two devices, i.e., host device 12 and client device 14 in the example of FIG. 1, system 10 may include a single device that incorporates the functionality described below with respect to both of host device 12 and client device 14, or multiple clients 14 that each interface with one or more host devices 12 that share a mutual database hosted by one or more of the host devices 12.

Host device 12 may represent any form of computing device capable of implementing the techniques described in this disclosure, including a handset (or cellular phone), a tablet computer, a so-called smart phone, a desktop computer, and a laptop computer to provide a few examples. Likewise, client device 14 may represent any form of computing device capable of implementing the techniques described in this disclosure, including a handset (or cellular phone), a tablet computer, a so-called smart phone, a desktop computer, a laptop computer, a so-called smart speaker, so-called smart headphones, and so-called smart televisions, to provide a few examples.

As shown in the example of FIG. 1, host device 12 includes a server 28, a CNLP unit 22, one or more execution platforms 24, and a database 26. Server 28 may 28 may represent a unit configured to maintain a conversational context as well as coordinate the routing of data between CNLP unit 22 and execution platforms 24.

Server 28 may include an interface unit 20, which may represent a unit by which host device 12 may present one or more interfaces 21 to client device 14 in order to elicit data 19 indicative of an input and/or present results 25. Data 19 maybe indicative of speech input, text input, image input (e.g., representative of text or capable of being reduced to text), or any other type of input capable of facilitating a dialog with host device 12. Interface unit 20 may generate or otherwise output various interfaces 21, including graphical user interfaces (GUIs), command line interfaces (CLIs), or any other interface by which to present data or otherwise provide data to a user 16. Interface unit 20 may, as one example, output a chat interface 21 in the form of a GUI with which the user 16 may interact to input data 19 indicative of the input (i.e., text inputs in the context of the chat server example). Server 28 may output the data 19 to CNLP unit 22 (or otherwise invoke CNLP unit 22 and pass data 19 via the invocation).

CNLP unit 22 may represent a unit configured to perform various aspects of the CNLP techniques as set forth in this disclosure. CNLP unit 22 may maintain a number of interconnected language sub-surfaces (shown as “SS”) 18A-18G (“SS 18”). Language sub-surfaces 18 may collectively represent a language, while each of the language sub-surfaces 18 may provide a portion (which may be different portions or overlapping portions) of the language. Each portion may specify a corresponding set of syntax rules and strings permitted for the natural language with which user 16 may 16 may interface to enter data 19 indicative of the input. CNLP unit 22 may perform CNLP, based on the language sub-surfaces 18 and data 19, to identify one or more intents 23. CNLP unit 22 may output the intents 23 to server 28, which may in turn invoke one of execution platforms 24 associated with the intents 23, passing the intents 23 to one of the execution platforms 24 for further processing. Another system that may perform CNLP is described in U.S. patent application Ser. No. 16/441,915, filed Jun. 14, 2019, entitled “CONSTRAINED NATURAL LANGUAGE PROCESSING,” the entire content of which is incorporated herein by reference.

Execution platforms 24 may represent one or more platforms configured to perform various processes associated with the identified intents 23. The processes may each perform a different set of operations with respect to, in the example of FIG. 1, databases 26. In some examples, execution platforms 24 may each include processes corresponding to different categories, such as different categories of data analysis including sales data analytics, health data analytics, or loan data analytics, different forms of machine learning, etc. In some examples, execution platforms 24 may perform general data analysis that allows various different combinations of data stored to databases 26 to undergo complex processing and display via charts, graphs, etc. Execution platforms 24 may process the intents 23 to obtain results 25, which execution platforms 24 may return to server 28. Interface unit 20 may generate a GUI 21 that present results 25, transmitting the GUI 21 to client device 14.

In this respect, execution platforms 24 may generally represent different platforms that support applications to perform analysis of underlying data stored to databases 26, where the platforms may offer extensible application development to accommodate evolving collection and analysis of data or perform other tasks/intents. For example, execution platforms 24 may include such platforms as Postgres (which may also be referred to as PostgreSQL, and represents an example of a relational database that performs data loading and manipulation), TensorFlow™ (which may perform machine learning in a specialized machine learning engine), and Amazon Web Services (or AWS, which performs large scale data analysis tasks that often utilize multiple machines, referred to generally as the cloud).

The client device 14 may include a client 30 (which may in the context of a chatbot interface be referred to as a “chat client 30”). Client 30 may represent a unit configured to present interface 21 and allow entry of data 19. Client 30 may execute within the context of a browser, as a dedicated third-party application, as a first-party application, or as an integrated component of an operating system (not shown in FIG. 1) of client device 14.

Returning to natural language processing, CNLP unit 22 may perform a balanced form natural language processing compared to other forms of natural language processing. Natural language processing may refer to a process by which host device 12 attempts to process data 19 indicative of inputs (which may also be referred to as “inputs 19” for ease of explanation purposes) provided via a conversational interaction with client device 14. Host device 12 may dynamically prompt user 16 for various inputs 19, present clarifying questions, present follow-up questions, or otherwise interact with the user in a conversational manner to elicit input 19. User 16 may 16 may likewise enter the inputs 19 as sentences or even fragments, thereby establishing a simulated dialog with host device 12 to identify one or more intents 23 (which may also be referred to as “tasks 23”).

Host device 12 may present various interfaces 21 by which to present the conversation. An example interface may act as a so-called “chatbot,” which may attempt to mimic human qualities, including personalities, voices, preferences, humor, etc. in an effort to establish a more conversational tone, and thereby facilitate interactions with the user by which to more naturally receive the input. Examples of chatbots include “digital assistants” (which may also be referred to as “virtual assistants”), which are a subset of chatbots focused on a set of tasks dedicated to assistance (such as scheduling meetings, make hotel reservations, and schedule delivery of food).

A number of different natural language processing algorithms exist to parse the inputs 19 to identify intents 23, some of which depend upon machine learning. However, natural language may not always follow a precise format, and various users may have slightly different ways of expressing inputs 19 that result in the same general intent 23, some of which may result in so-called “edge cases” that many natural language algorithms, including those that depend upon machine learning, are not programed (or, in the context of machine language, trained) to specifically address. Machine learning based natural language processing may value naturalness over predictability and precision, thereby encountering edge cases more frequently when the trained naturalness of language differs from the user's perceived naturalness of language. Such edge cases can sometimes be identified by the system and reported as an inability to understand and proceed, which may frustrate the user. On the other hand, it may also be the case that the system proceeds with an imprecise understanding of the user's intent, causing actions or results that may be undesirable or misleading.

Other types of natural language processing algorithms utilized to parse inputs 19 to identify intents 23 may rely on keywords. While keyword based natural language processing algorithms may be accurate and predictable, keyword based natural language processing algorithms are not precise in that keywords do not provide much if any nuance in describing different intents 23.

In other words, various natural language processing algorithms fall within two classes. In the first class, machine learning-based algorithms for natural language processing rely on statistical machine learning processes, such as deep neural networks and support vector machines. Both of these machine learning processes may suffer from limited ability to discern nuances in the user utterances. Furthermore, while the machine learning based algorithms allow for a wide variety of natural-sounding utterances for the same intent, such machine learning based algorithms can often be unpredictable, parsing the same utterance differently in successive versions, in ways that are hard for developers and users to understand. In the second class, simple keyword-based algorithms for natural language processing may match the user's utterance against a predefined set of keywords and retrieve the associated intent.

In accordance with the techniques described in this disclosure, CNLP unit 22 may parse inputs 19 (which may as one example, include natural language statements that may also be referred to as “utterances”) in a manner that balances accuracy, precision, and predictability. CNLP unit 22 may achieve the balance through various design decisions when implementing the underlying language surface (which is another way of referring to the collection of sub-surfaces 18, or the “language”). Language surface 18 may represent a set of potential user utterances for which server 28 is capable of parsing (or, in more anthropomorphic terms, “understanding”) the intent of the user 16.

The design decisions may negotiate a tradeoff between competing priorities, including accuracy (e.g., how frequently server 28 is able to correctly interpret the utterances), precision (e.g., how nuanced the utterances can be in expressing the intent of user 16), and naturalness (e.g., how diverse the various phrasing of an utterance that map to the same intent of user 16 can be). The CNLP techniques may allow CNLP unit 22 to unambiguously parse inputs 19 (which may also be denoted as the “utterances 19”), thereby potentially ensuring predictable, accurate parsing of precise (though constrained) natural language utterances 19.

CNLP unit 22 may parse various pattern statements for similar data exploration and analysis tasks. For example, inputs 19 that express “Load myfile.csv”, “Import data from the file myfile.csv”, “Upload the dataset myfile.csv” all express the same intent. CNLP unit 22 may parse various inputs 19 to identify intent 23. CNLP unit 22 may 22 may provide intent 23 to server 28, which may invoke one or more of execution platforms 26, passing the intent 23 to the execution platforms 26 in the form of a pattern and associated entities, keywords, and the like. The invoked ones of execution platforms 26 may execute a process associated with intent 23 to perform an operation with respect to corresponding ones of databases 26 and thereby obtain result 25. The invoked ones of execution platforms 26 may provide result 25 (of performing the operation) to server 28, which may provide result 25, via interface 21, to client device 14 interfacing with host device 12 to enter input 19.

For example, consider a chatbot designed to perform various categories of data analysis, including loading and cleaning data, slicing and dicing it to answer various business-relevant questions, visualizing data to recognize patterns, and using machine learning techniques to project trends into the future. Using the techniques described herein, the designers of such a system can specify a large language surface that allows users to express intents corresponding to these diverse tasks, while potentially constraining the utterances to only those that can be unambiguously understood by the system, thereby avoiding the edge-cases. Further, the language surface can be tailored to ensure that, using the auto-complete mechanism, even a novice user can focus on the specific task they want to perform, without being overwhelmed by all the other capabilities in the system. For instance, once the user starts to express their intent to plot a chart summarizing their data, the system can suggest the various chart formats from which the user can make their choice. Once the user selects the chart format (e.g., a line chart), the system can suggest the axes, colors and other options the user can configure.

The system designers can specify language sub-surfaces (e.g., utterances for data loading, for data visualization, and for machine learning), and the conditions under which they would be exposed to the user. For instance, the data visualization sub-surface may only be exposed once the user has loaded some data into the system, and the machine learning sub-surface may only be exposed once the user acknowledges that they are aware of the subtleties and pitfalls in building and interpreting machine learning models. That is, this process of gradually revealing details and complexity in the natural language utterances extends both across language sub-surfaces as well as within it.

Taken together, the CNLP techniques can be used to build systems with user interfaces that are easy-to-use (e.g., possibly requiring little training and limiting cognitive overhead), while potentially programmatically recognizing a large variety of intents with high precision, to support users with diverse needs and levels of sophistication. As such, these techniques may permit novel system designs achieving a balance of capability and usability that is difficult or even impossible otherwise.

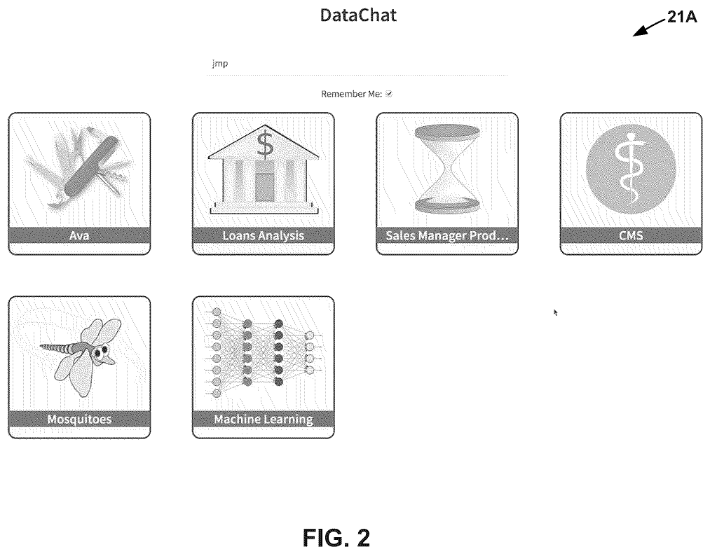

FIG. 2 is a diagram illustrating an example interface 21A presented by interface unit 20 of host device 12 of FIG. 1 that includes a number of different applications 100A-100F executed by execution platform 26 of FIG. 1. Application 100A, for example, represents a general chatbot interface for performing data analytics with respect to one or more of databases 26. In some examples, application 100B represents a loan analysis application for analyzing loan data stored to one or more of databases 26, application 100C represents a sales manager productivity application for analyzing sales manager productivity data stored to one or more of databases 26, application 100D represents a medical cost analysis application for analyzing medical cost data stored to one or more of databases 26, application 100E represents a scientific data analysis application for analyzing experimental data regarding prevalence of different mosquito species, collected by a scientific research group and stored to one or more of databases 26, and application 100F represents a machine learning application for performing machine learning with respect to data stored to one or more of databases 26.

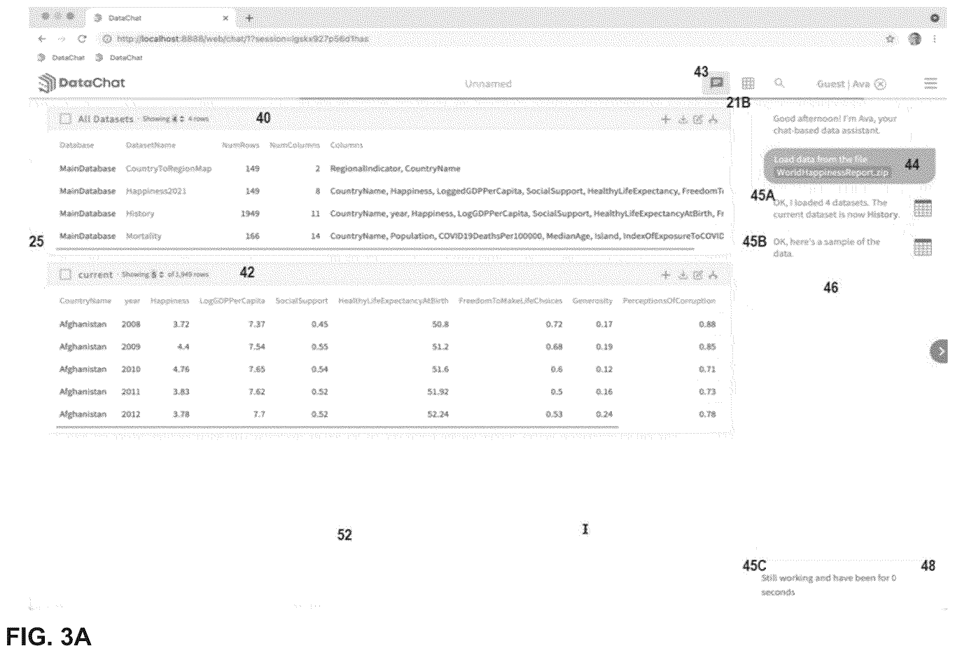

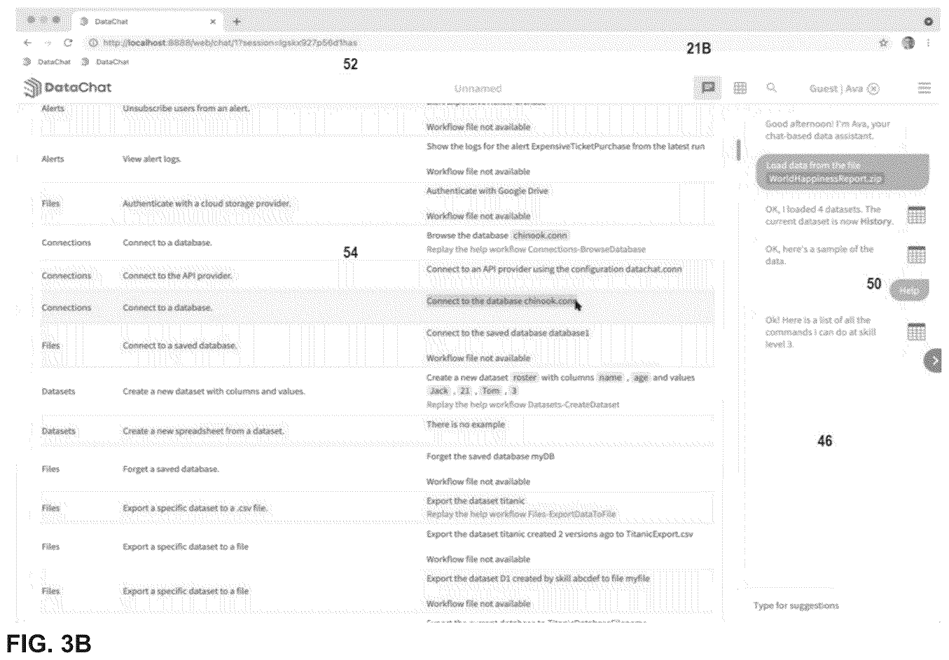

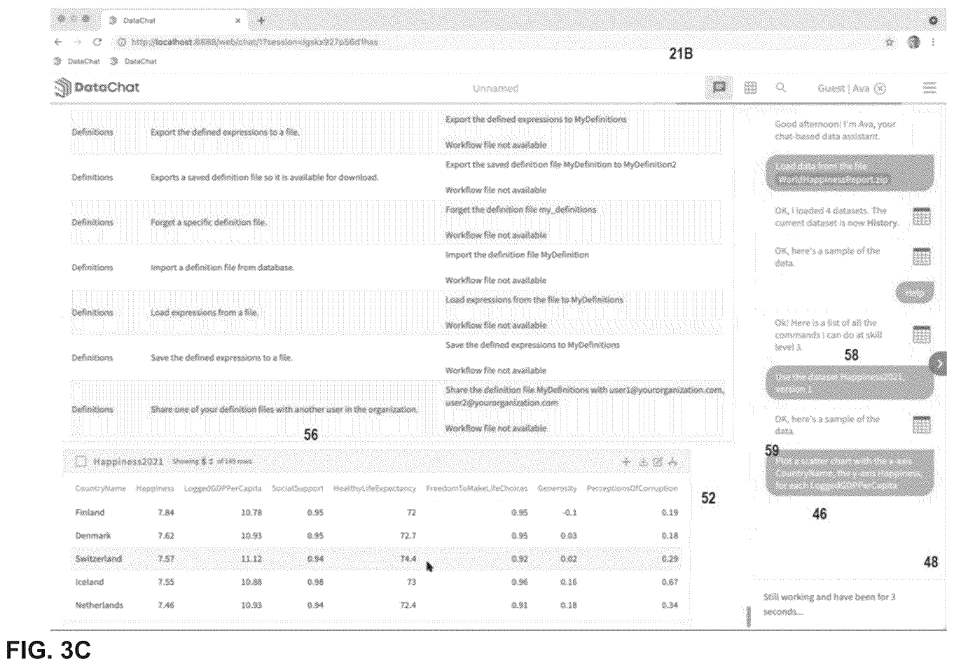

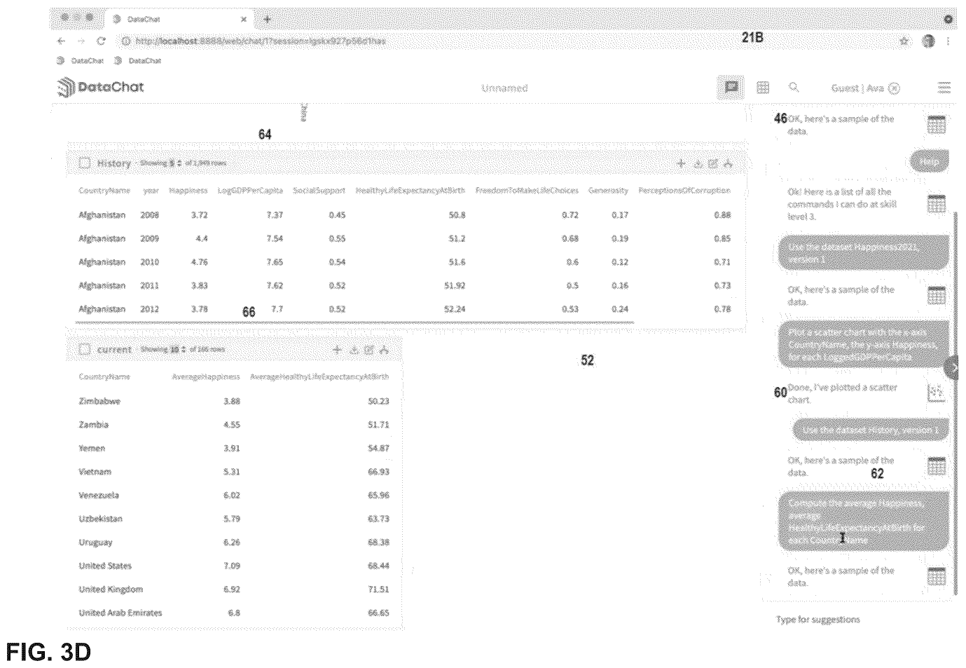

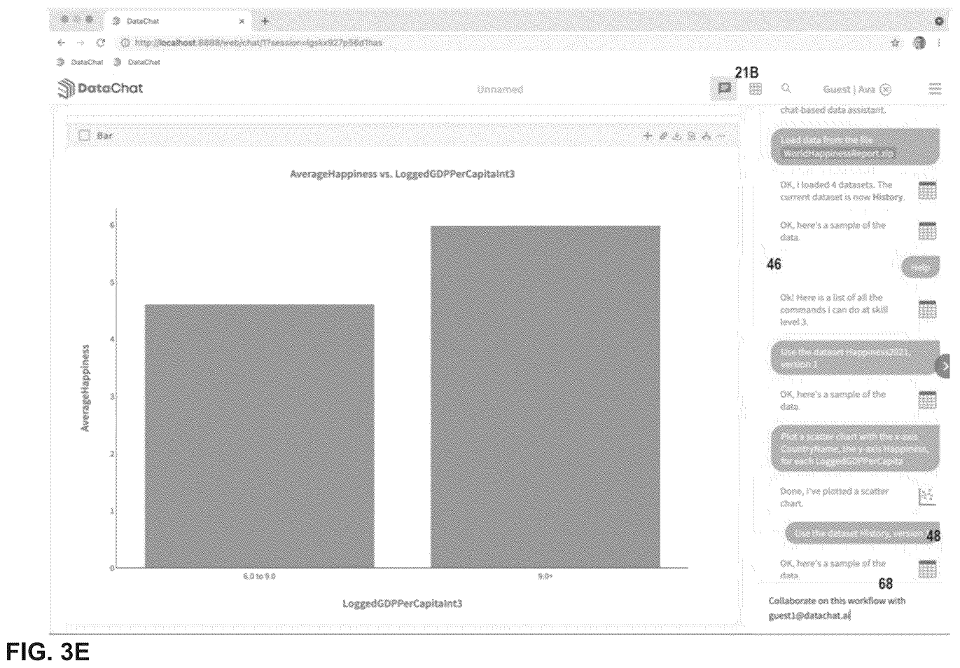

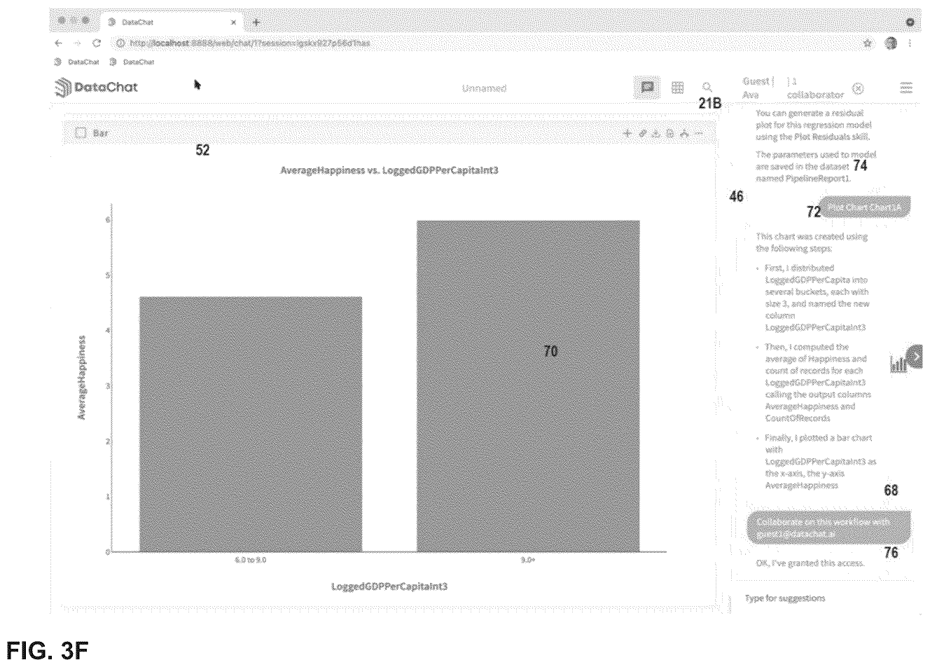

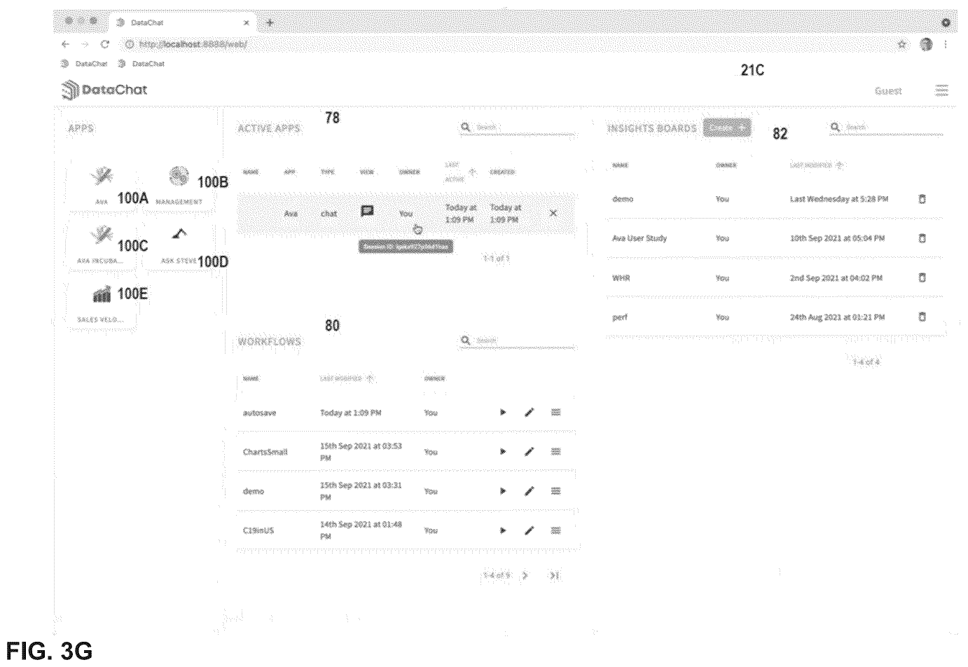

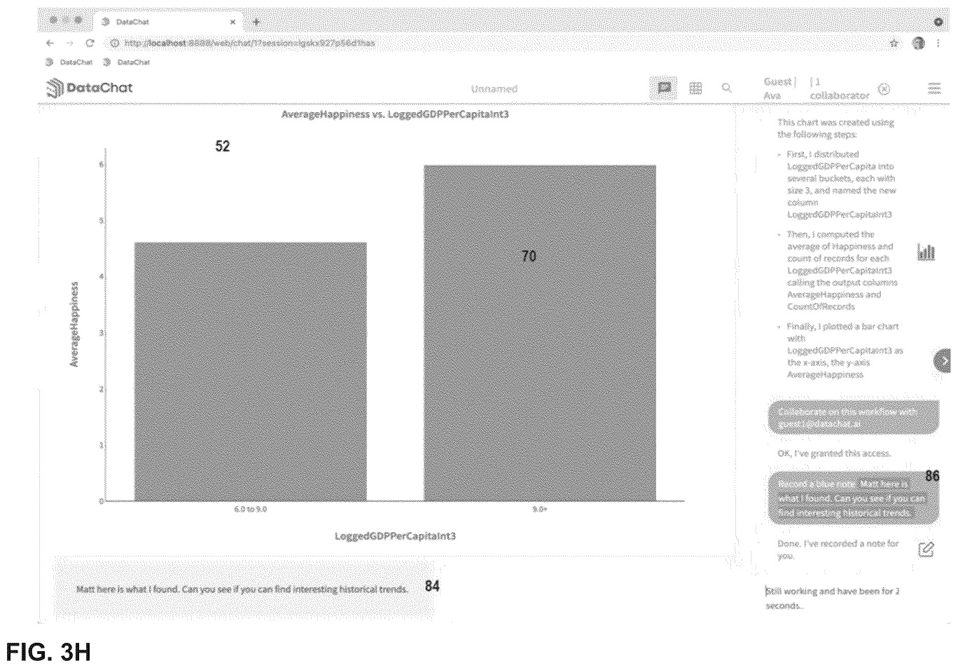

FIGS. 3A-3H are diagrams illustrating an example interface 21B that represents a “notebook view” presented by interface unit 20 of host device 12 that facilitates data analytics via general chatbot interface application 100A in accordance with various aspects of the CNLP techniques described in this disclosure. As described herein and shown throughout FIGS. 3A-3H, the notebook view may be considered one aspect of the user interface presented by application 100A that allows a user with little training or limited cognitive overhead to easily perform a variety of sophisticated tasks. Further, the notebook view of application 100A may allow a user to view recorded interactions, tasks, conversations, etc. between the user and the system so that at a later point in time, the user can revisit application 100A and understand the previous actions that were performed.

For example, the notebook view may provide, via a first portion of the user interface (e.g., a first frame), an interactive text box that allows one or more users to express intents via natural language. The notebook view may also include a second portion (e.g., a second frame) that presents an interactive log of previous inputs and responses from the natural language processing engine, which allows the one or more users to quickly assess how the results and/or responses were derived. The notebook view may also include a third portion (e.g., a third frame) that presents a graphical representation of the results provided responsive to any inputs. Throughout the examples provided by FIGS. 3A-3H, the second and third portions of the notebook view user interface are separately scrollable but coupled such that interactions in either the second or third portions of the notebook view user interface synchronize the second and third portions of the notebook view user interface.

In some examples, the second portion of the notebook view user interface is located above the first portion of the notebook view user interface, and the first portion of the notebook view user interface and the second portion of the notebook view user interface are located along a right boundary of the third portion of the notebook view user interface.

In other words, rather than presenting a cluttered user interface in which users struggle to interact with the system and/or understand the results produced by the system, the notebook view user interface is presented with more cohesive, user-friendly, and organized portions. Further, the employment of natural language processing by the notebook view may allow users to interact with the system more easily and understand results produced by the system more intuitively. For example, the second portion of the notebook view user interface that includes the historical log of interactions may allow users to quickly assess how results and/or responses were derived, as the historical log includes simple sentences or “recipes” that were used to interact with the system. Additionally, the second and third portions of the notebook view user interface may be separately scrollable to accommodate how different users understand different aspects of the results. Similar to human psychology in which predominantly right-brain users respond to creative and artistic stimuli and predominant left-brain users respond to logic and reason, the user interface divides the representation of the result into right-brain stimuli (e.g., graphical representation of the results in the third portion of the user interface) and left-brain stimuli (e.g., a historical log explaining how the results were logically derived in the second portion of the user interface). Regardless of the user's predominance of right-brain or left-brain, the user interface may synchronize the third portion with the second portion responsive to interactions with either the second portion or the third portion. The synchronization of the second and third portions of the notebook view user interface may allow users to better comprehend the results presented by the third portion, as the steps taken to achieve the results presented by the third portion are included in the historical log presented by the second portion.

In the example of FIG. 3A, interface unit 20 has presented interface 21B in response to user 16 selecting notebook button 43 that includes an interactive log 46 that displays an interactive log including recorded dialog between user 16 and the system or “chatbot” and a results presentation portion 52 that presents results 25. Interactive log 46 may be presented above an interactive text box 48 with which user 16 may interact to enter, for example, input 44 specifying “Load data from the file WorldHappinessReport.zip”. Interactive text box 48 may automatically perform an autocomplete operation to facilitate entry of the current input. Interactive text box 48 may limit a number of autocomplete recommendations (which may be referred to as “recommendations”) to a threshold number of recommendations (as there may be a large number—e.g., 10, 20, . . . 100, . . . 1000, etc. of recommendations). Interactive text box 48 may limit the number of recommendations to reduce clutter and facilitate user 16 in selecting a recommendation that is most likely to be useful to user 16. User interface 21B may prioritize recommendations based on preferences set by user 16, recency of accessing a various file, or any other priority based algorithm (including machine-learning or other artificial intelligent priority and/or ranking algorithms).

In the example of FIG. 3A, in response to user 16 entering input 44, server 28 may interface with corresponding execution platform 26 to obtain results 25 that are in response to identifying an intent associated with the ‘LOAD DATA’ pattern of input 44. That is, results presentation portion 52 presents results 25, which in the example of FIG. 3A includes dataset element 40 and sample data element 42. Dataset element 40 includes all datasets in the file requested by user 16 and sample data element 42 includes a sample of the data in a selected dataset. Application 100A may also receive input 44 and send messages 45A-45C in interactive log 46 that indicate the status of the requested command. Input 44 and messages 45A-45C may be recorded in interactive log 46 so that user 16 and/or other users can review the interactions, tasks, conversations, etc. between user 16 and the system at a later point in time. In the example of FIG. 3A, and in other examples described herein, interface unit 20 may 20 may generate or otherwise obtain interface 21B that includes all of the interface elements, providing interface 21B to user 16 via client 30.

FIG. 3B is another view of FIG. 3A in which interface unit 20 has presented interface 21B in response to user 16 entering input 50 specifying “Help” in interactive text box 48. In response to user 16 entering input 50, server 28 may interface with corresponding execution platform 26 to obtain results 25 that are in response to identifying an intent associated with the ‘HELP’ pattern of input 50. That is, results presentation portion 52 presents commands element 54 that lists all the commands that general chatbot interface application 100A can perform. In the example of FIG. 3B, commands element 54 displays commands such as “Connect to a database”, “Forget a saved database”, and “Export a specific dataset to a file”. The list of commands that application 100A can perform are not limited to the list of commands displayed in commands element 54 and are for exemplary purposes only. As in the example of FIG. 3A, and in other examples described herein, application 100A may receive input from user 16 and send subsequent messages indicating the status of the requested command, wherein the received input and the subsequent messages may be recorded in interactive log 46.

FIG. 3C is another view of FIG. 3B in which interface unit 20 has presented interface 21B in response to user 16 entering input 58 specifying “Use the dataset Happiness2021, version 1” in interactive text box 48. In response to user 16 entering input 58, server 28 may interface with corresponding execution platform 26 to obtain results 25 presented as sample data element 56 in results presentation field 52, i.e., server 28 may receive and analyze input 58 to automatically present a sample of the requested Happiness2021 dataset. In the example of FIG. 3C, user 16 has also entered input 59 specifying “Plot a scatter chart with the x-axis CountryName, the y-axis Happiness, for each LoggedGDPPerCapita”. Although not shown in the example of FIG. 3C, in response to user 16 entering input 59, server 28 may interface with corresponding execution platform 26 to obtain results 25 that include a scatter chart displaying the information specified by the user.

FIG. 3D is another view of FIG. 3C in which interface unit 20 has presented interface 21B in response to user 16 entering input 60 specifying “Use the dataset History, version 1”, as shown in interactive log 46. In response to user 16 entering input 60, server 28 may interface with corresponding execution platform 26 to obtain results 25 presented as sample data element 64 in results presentation field 52. Sample data element 64, in this example, may be a table displaying a selected number of rows in the History dataset. Also in the example of FIG. 3D, interface unit 20 has presented interface 21B in response to user 16 entering input 62 specifying “Compute the average Happiness, average HealthyLifeExpectancyAtBirth for each CountryName”, as shown in text presentation field 46. In response to user 16 entering input 62, server 28 may 28 may interface with corresponding execution platform 26 to obtain results 25 presented as table 66 in results presentation field 52. Table 66, in this example, may be a sample of the results of the operations performed by application 100A in response to input 62.

FIG. 3E is another view of FIG. 3D in which interface unit 20 has presented interface 21B in response to user 16 entering input 68 specifying “Collaborate on this workflow with guest1@datachat.ai”, as shown in interactive log 46. In response to user 16 entering input 68, server 28 may interface with corresponding execution platform 26 to grant access to a second user, in which interface 21B may also be presented to the second user via client 30. The second user may then be able to enter inputs in interactive text box 48 that server 28 can respond to. For example, user 16 may enter input 68 specifying “Collaborate on this workflow with guest1@datachat.ai”, and then server 28 may interface with corresponding execution platform 26 to grant access to a second user 17 (not shown in FIG. 3E) that can also enter inputs in interactive text box 48. Additionally, user 17 maybe able to view the recorded interactions, tasks, conversations, etc. between user 16 and the system and understand the previous actions that were performed.

FIG. 3F is another view of FIG. 3E in which interface unit 20 has presented interface 21B in response to user 16 entering input 74 specifying “Plot Chart Chart1A”, as shown in interactive log 46. In response to user 16 entering input 74, server 28 may 28 may interface with corresponding execution platform 26 to obtain results 25 presented as chart 70 in results presentation field 52. In the example of FIG. 3F, chart 70 is a bar chart showing AverageHappiness as a function of LoggedGDPPerCapitaInt3. Interactive log 46 may also show message 72 sent by application 100A that details the steps or operations performed by application 100A to generate chart 70. The example of FIG. 3F also includes input 68 of FIG. 3E specifying “Collaborate on this workflow with guest1@datachat.ai”. In the example of FIG. 3F, upon granting access to a second user, application 100A sends message 58 in interactive log 46 that states, “OK, I′ve granted this access”. A second user 17 may then see application 100A as an active application in a dashboard similar to that of FIG. 3G.

In the example of FIG. 3G, interface unit 20 has presented example dashboard interface 21C that includes a number of different applications 100A-100E executed by execution platforms 26. Dashboard interface 21C may also display active apps portion 78 that shows which of applications 100A-100E are active. Dashboard interface 21C may also display workflows portion 80 that shows any workflows that have been created for various projects. Dashboard interface 21C may also display an insights board portion 82 that shows projects for which insights, such as project name, project owner, and last modification date, are available. Upon a second user 17 being granted access to collaborate with user 16, such as in the example of FIG. 3F, second user 17 may see user 16's session in active apps portion 78 of dashboard interface 21C and have the ability to click on the session to view or collaborate on it.

FIG. 3H is another view of FIG. 3F in which user 16 has entered an additional input 86 specifying “Record a blue note Matt here is what I found. Can you see if you can find interesting historical trends”, as shown in text presentation field 46. Input 86 may represent a command that results in text element 84 being added to results presentation portion 52. Text element 84 may serve as a note from one user 16 to second user 17.

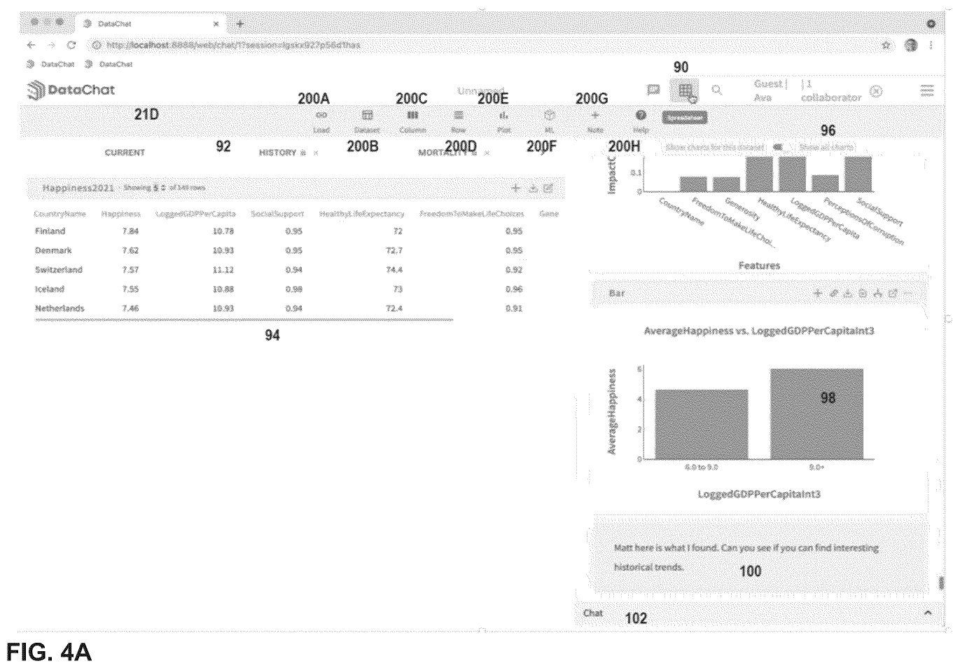

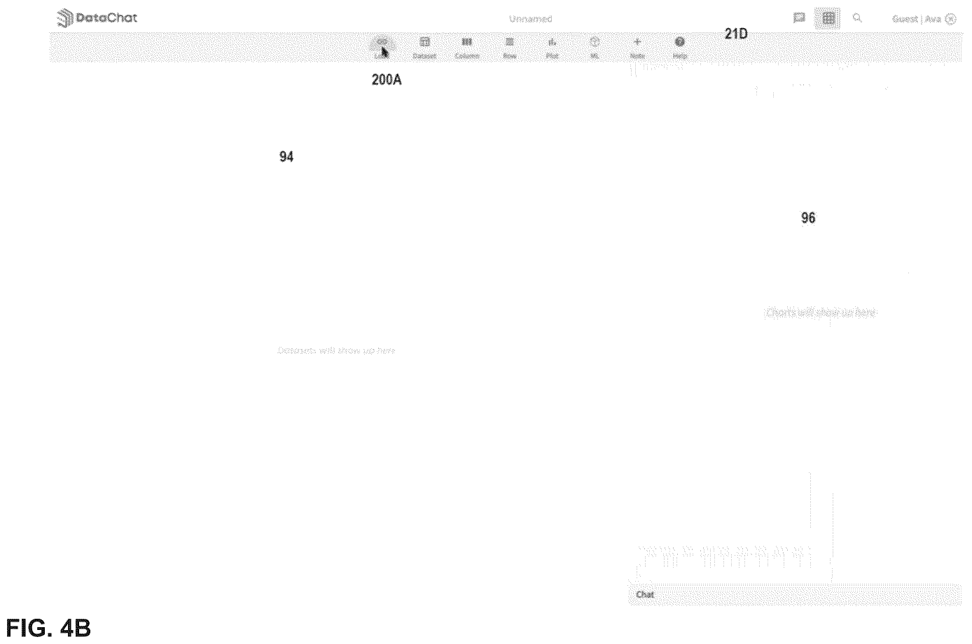

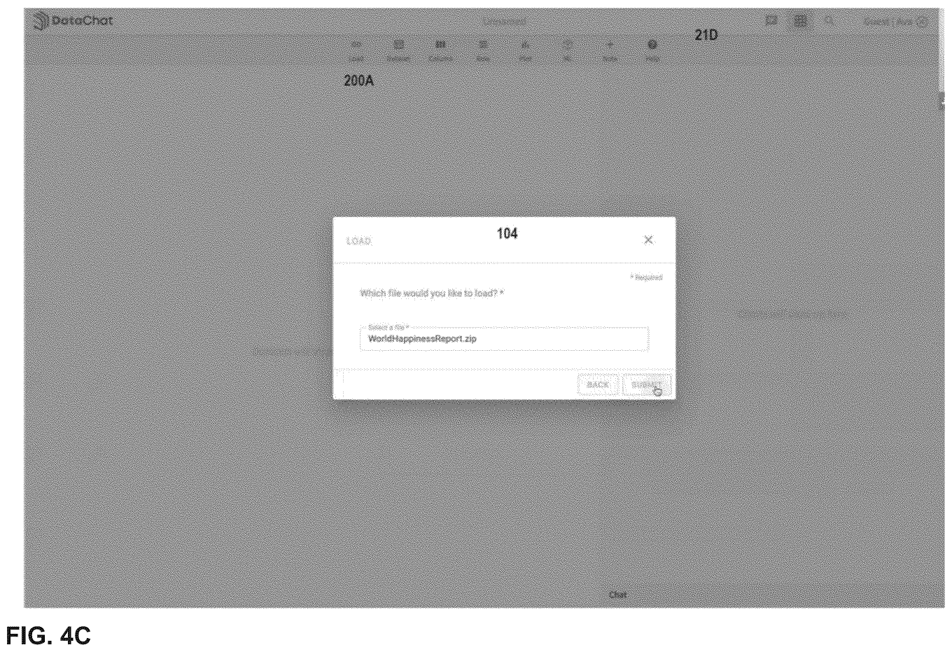

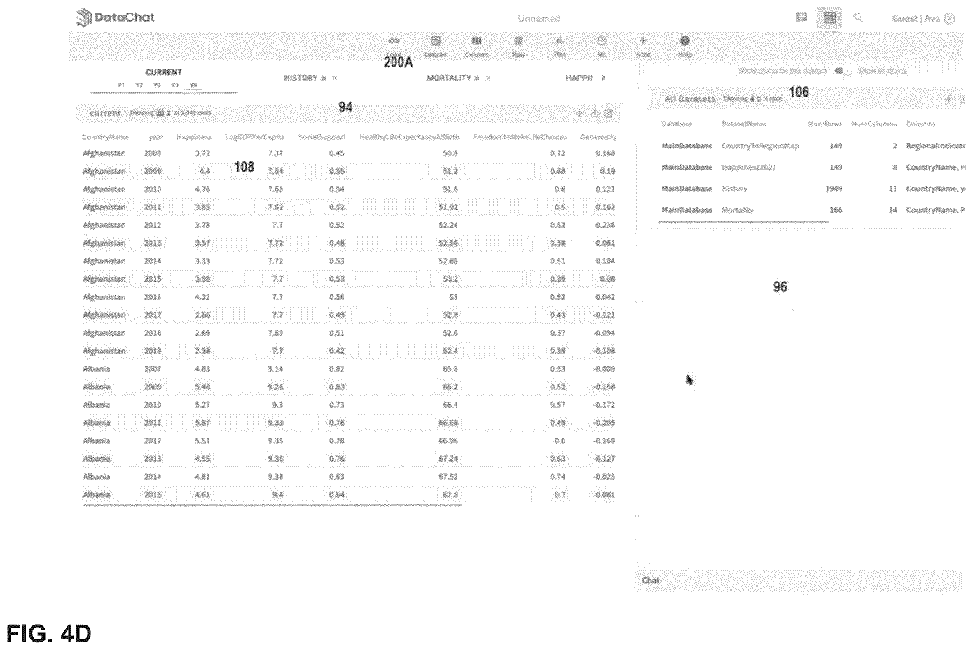

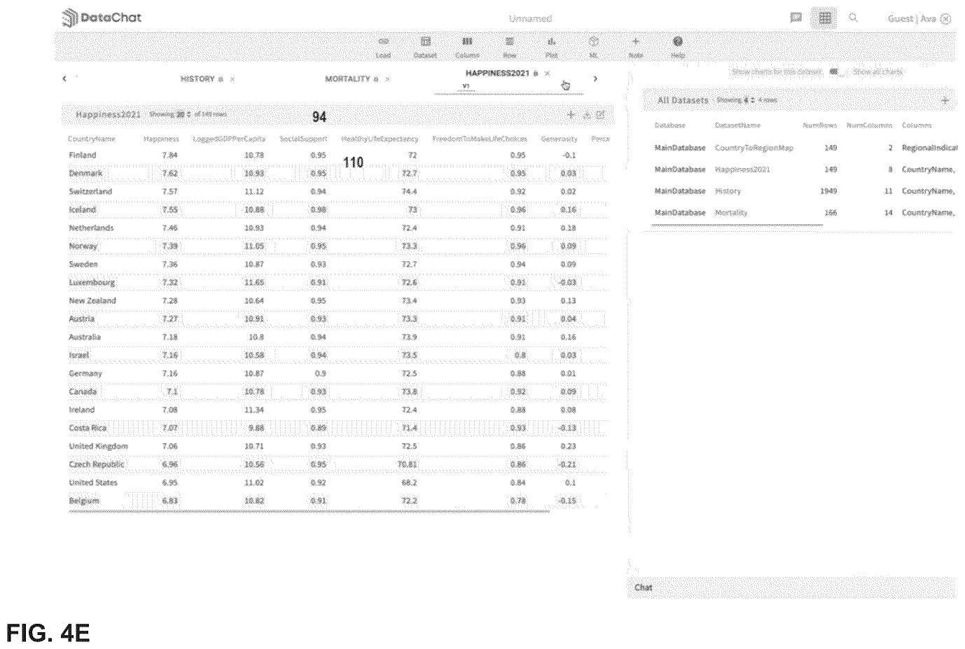

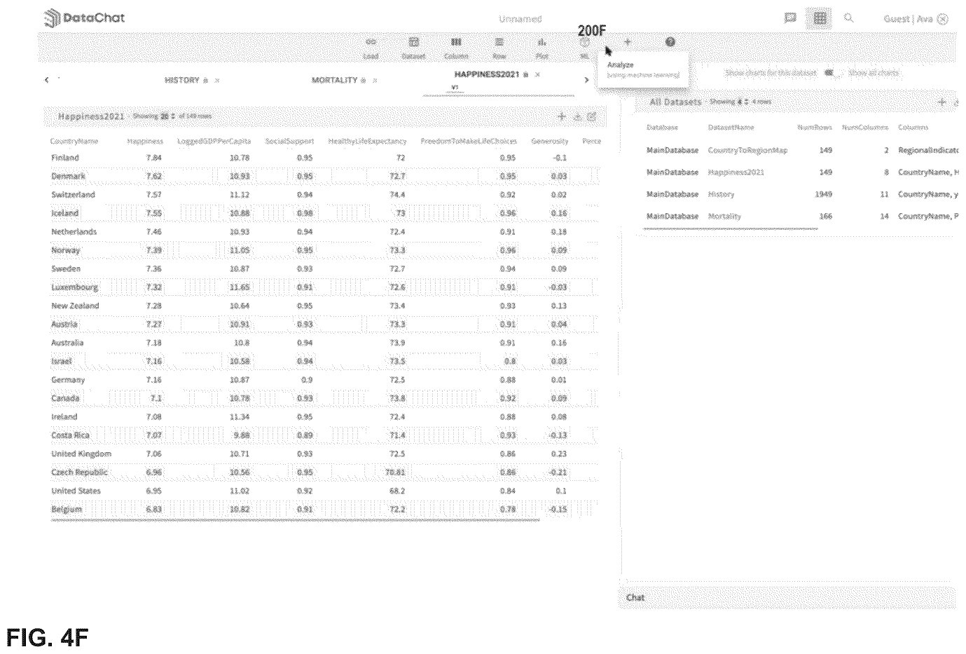

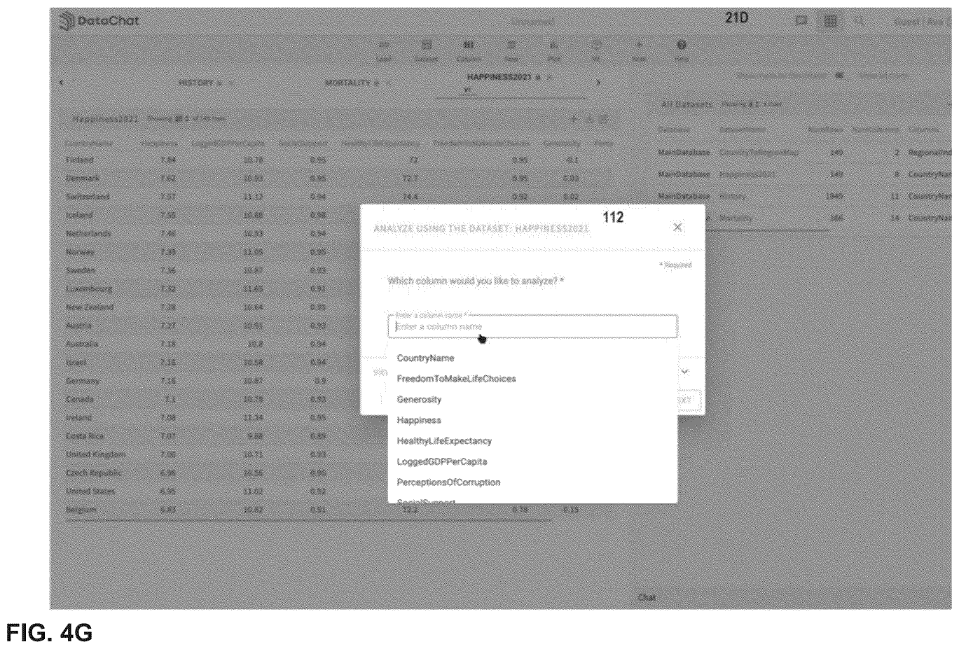

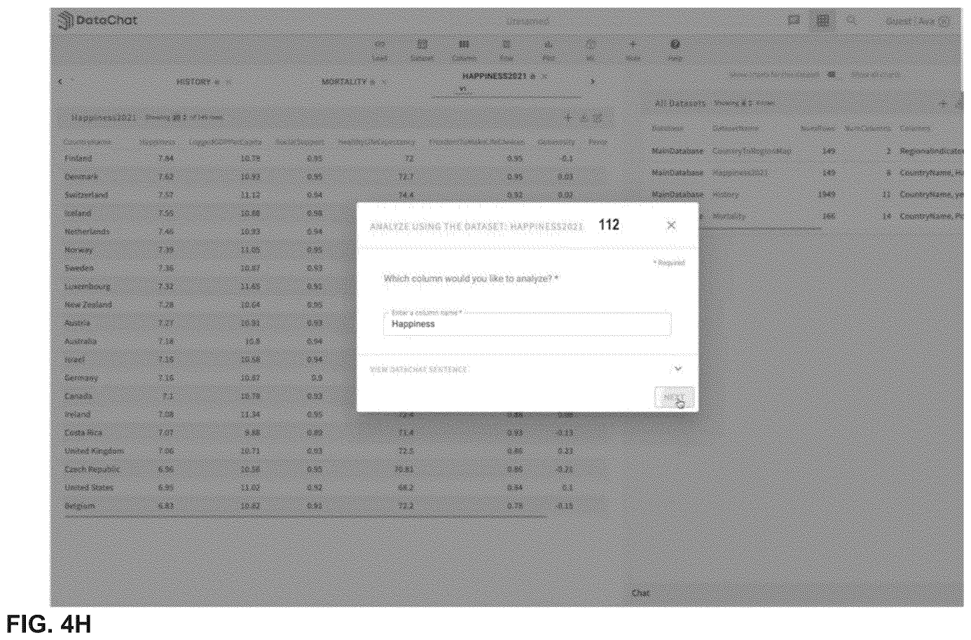

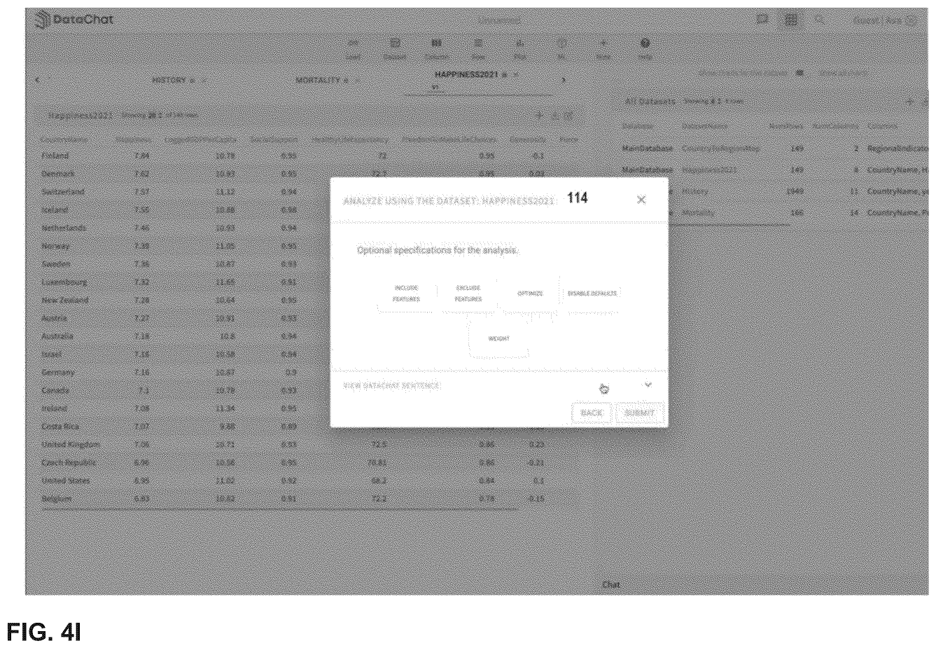

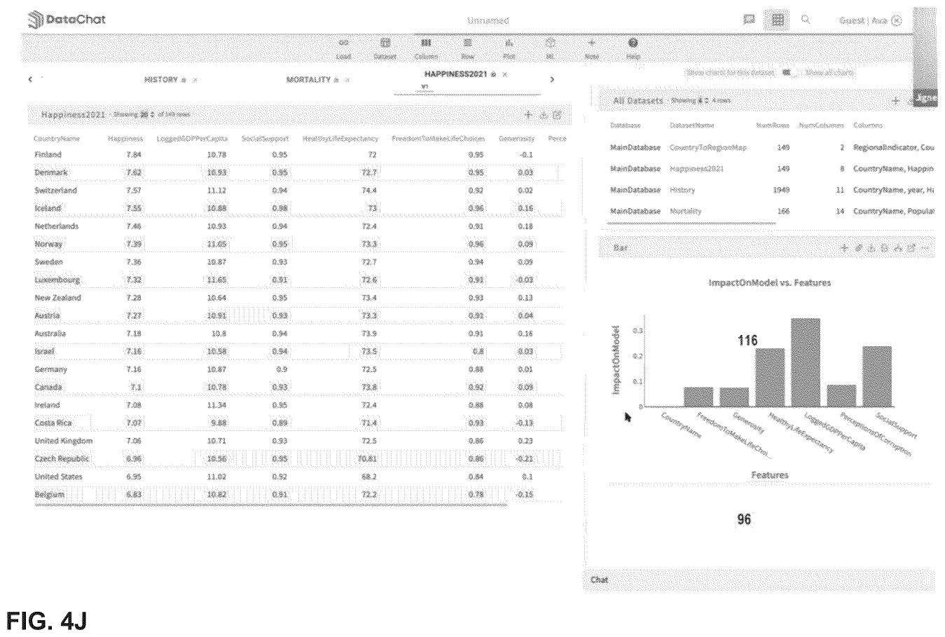

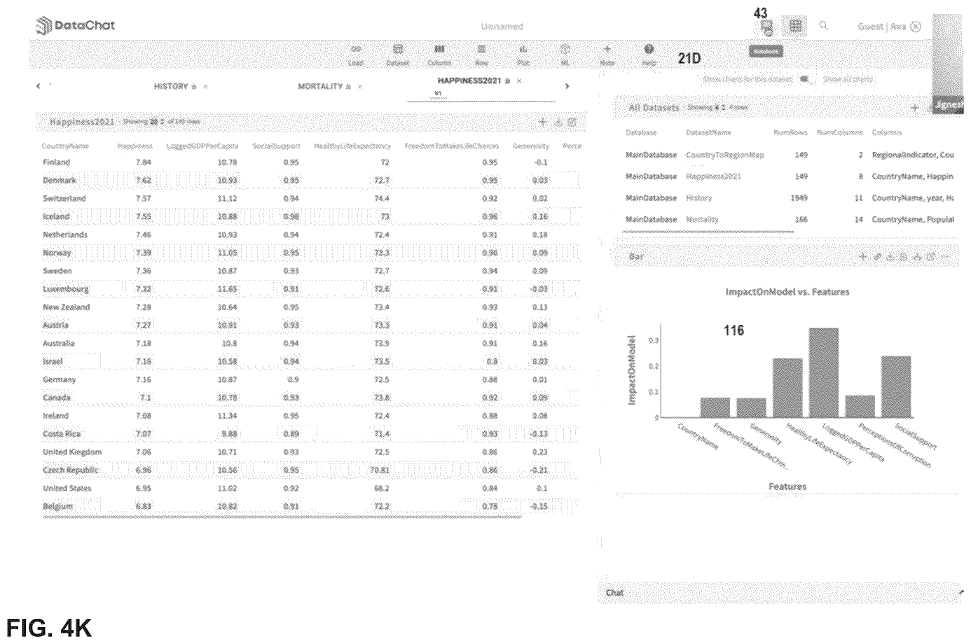

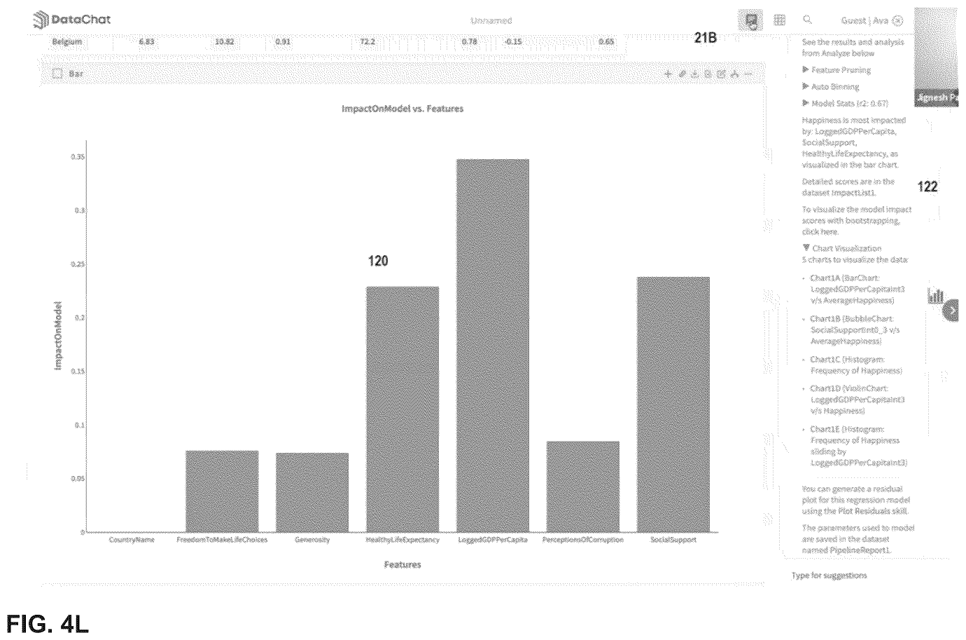

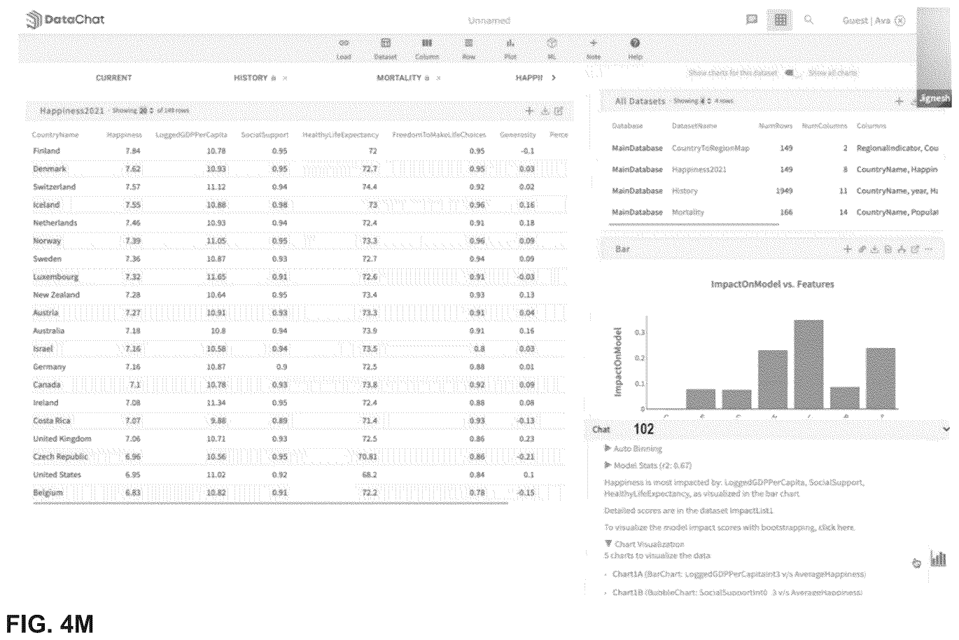

FIGS. 4A-4M are diagrams illustrating interface 21D that represents a “spreadsheet view” presented by interface unit 20 of host device 12 that facilitates data analytics via general chatbot interface application 100A in accordance with various aspects of the CNLP techniques described in this disclosure. As described herein and shown throughout FIGS. 4A-4M, the spreadsheet view may be considered another aspect of the user interface presented by application 100A that allows one or more users to easily load, view, manipulate, analyze, and visualize data. Further, similar to the previously described notebook view, the spreadsheet view of application 100A may allow one or more users to view recorded interactions, tasks, conversations, etc. between the one or more users and the system so that at a later point in time, the one or more users can revisit application 100A and understand the previous actions that were performed. For example, the spreadsheet view may include a first portion (e.g., a first frame) that presents the interactive log of previous inputs and responses from the natural language processing engine included in the notebook view, thus enabling the one or more users to toggle between the notebook view and spreadsheet view without losing any results or historical information. The spreadsheet view may also include a second portion (e.g., a second frame) that presents the graphical representation of the results provided responsive to any inputs also included in the notebook view. The spreadsheet view may also include a third portion (e.g., a third frame) that presents one or more datasets that the one or more users can analyze or visualize. The spreadsheet view may also include a fourth portion (e.g., a fourth frame) that presents at least a portion of the multi-dimensional data included in the one or more datasets. Throughout the examples provided by FIGS. 4A-4M, the first and second portions of the spreadsheet view user interface are separately scrollable but coupled such that interactions in either the first and second portions of the spreadsheet view user interface synchronize the first and second portions of the spreadsheet view user interface.

In some examples, the second portion of the spreadsheet view user interface is located above the first portion of the spreadsheet view user interface, the third portion of the spreadsheet view user interface is located above the second portion of the spreadsheet view user interface, and the first, second, and third portions of the spreadsheet view user interface are located along a right boundary of the fourth portion of the spreadsheet view user interface.

In other words, rather than presenting a cluttered or multipage spreadsheet in which users struggle to manipulate and visualize multi-dimensional data, the spreadsheet view user interface is presented with more organized portions that allow users to easily load, view, manipulate, analyze, and visualize multi-dimensional data all in one place. The spreadsheet view user interface, similar to the notebook view user interface, employs natural language processing that may allow users to interact with the system more easily and understand results produced by the system more intuitively. Further, the spreadsheet view user interface may allow users to interact with the system via mouse clicks instead of, for example, typing formulas or pressing various combinations of keys. Additionally, when a user decides to transition from the notebook view user interface to the spreadsheet view user interface or vice versa, all of the sentences or “recipes” that were used to interact with the system included in the historical log as well as all of the graphical representations of the results will be reproduced and/or translated onto either user interface. Thus, users can toggle between the spreadsheet view user interface and the notebook view user interface and still see the same information. Additionally, the spreadsheet view user interface may facilitate generation of visual representations of the multi-dimensional data via graphical representations of the format for such visual representations, which may enable more visual (e.g., right-brain predominant) users to create complicated visual representations of the multi-dimensional data that would otherwise be difficult and time consuming.

In the example of FIG. 4A, interface unit 20 has presented interface 21D that represents a spreadsheet view that displays elements similar to those included in interface 21B of FIGS. 3A-3H. That is, in response to user 16 selecting spreadsheet button 90, interface unit 20 may generate interface 21D that includes elements of interface 21B, or the notebook view, in a different configuration. Interface unit 20 may 20 may provide interface 21D to user 16 via client 30. In the example of FIG. 4A, interface 21D includes operation buttons 200A-200H, interactive log 102, sample data presentation section 94 including sample data element 92, and results presentation section 96 including chart element 98 and text element 100. The spreadsheet view presented in interface 21D may allow users to explore sample data element 92 while it is presented in a spreadsheet format in sample data presentation section 94. Other elements such as chart element 98 and text element 100 may be displayed in results presentation section 96. Interface 21D may also include interactive log 102 that displays recorded interactions, tasks, conversations, etc. between the user and the system. Interactive log 102 may be substantially similar to interactive log 46 of FIG. 3A and include the same recorded information.

In the example of FIG. 4B, interface unit 20 has presented interface 21D in response to user 16 resetting and reloading application 100A. In some examples, resetting and reloading application 100A may clear any recorded interactions, tasks, conversations, etc. between the user and the system. Additionally, resetting and reloading the 100A may discontinue any additional user's access to user 16′s active session in application 100A. As shown in FIG. 4B, results presentation portion 204 and results presentation portion 206 are empty. To load a dataset, user 16 may select “Load” operation button 200A.

In the example of FIG. 4C, interface unit 20 has presented interface 21D that presents popup element 104 in response to user 16 selecting “Load” operation button 200A. After selecting “Load” operation button 200A, user 16 may choose between a file and a source to load into application 100A. In the example of FIG. 4C, user 16 elects to load a file, in which interface 21D then displays popup element 104 where user 16 can select one or more specific files to load.

In the example of FIG. 4D, interface unit 20 has presented interface 21D in response to user 16 loading a dataset via “Load” operation button 200A. In the example of FIG. 4D, sample data presentation portion 94 may present sample data element 108 that includes a sample of the data in a selected dataset. Interface 21D may include dataset table element 106 that displays the names of all datasets that have been loaded by user 16. As shown in the example of FIG. 4D, tabs for each dataset in dataset table element 106 may be displayed at the top of results presentation section 96 and user 16 maybe able to click between them to view a sample of each dataset.

FIG. 4E displays another view of FIG. 4D in which the user has selected the tab for the HAPPINESS2021 dataset. Sample data presentation portion 94 then presents sample data element 110 that includes a sample of the data in the selected HAPPINESS521 dataset.

FIG. 4F displays another view of FIG. 4D in which the user has hovered over “ML” operation button 200F included in interface 21D. “ML” operation button 200F may be selected by user 16 to analyze a dataset using machine learning methods.

In the example of FIG. 4G, interface unit 20 has presented popup element 112 in response to user 16 selecting “ML” operation button 200F. After selecting “ML” operation button 200F, user 16 may choose a column from a selected dataset to analyze. In the example of FIG. 4G, interface 21D displays popup element 112 where user 16 can select a column from the HAPPINESS2021 dataset to analyze.

FIG. 4H displays another view of FIG. 4G including popup element 112 in which user 16 has selected the “Happiness” column from the HAPPINESS2021 dataset to analyze.

FIG. 4I depicts a further configuration of the “ML” operation button 200F in which interface unit 20 has presented popup element 114 is which user 16 has already selected a specific column to analyze. In the example of FIG. 4I, popup element 114 provides user 16 optional specifications for the analysis of the specific column. The optional specifications may include, but is not limited to, inclusion or exclusion of features, optimization, disabling of defaults, and weighting.

FIG. 4J displays another view of FIG. 4F in which an additional bar chart 116 is presented in results presentation section 96. In the example of FIG. 4J, bar chart 116 displays “ImpactOnModel” versus “Features”.

FIG. 4K displays another view of FIG. 4J in which user 16 has hovered over notebook button 43 included in interface 21D. User 16 may switch between the notebook view of FIGS. 3A-3H and spreadsheet view of FIGS. 4A-4M with both views presenting the same information. All of the interactions, tasks, conversations, etc. between user 16 and the system in the spreadsheet view can be reproduced or translated into the notebook view format. As described herein, the notebook view format may also record include all of the interactions, tasks, conversations, etc. between user 16 and the system to ensure transparency.

In the example of FIG. 4L, interface unit 20 has presented interface 21B that represents a notebook view of the elements previously presented by interface 21D, such as bar chart 120. In the example of FIG. 4L, interface 21B that includes an interactive log 122 that displays recorded interactions, tasks, conversations, etc. between user 16 and the system. Thus, user 16 can switch between the spreadsheet view and the notebook view without losing information. User 16 can also review interactive log 122 at a later point in time and understand the actions taken to produce certain elements.

FIG. 4M displays another view of FIG. 4K in which interactive log 102 has been expanded to display all of the recorded interactions, tasks, conversations, etc. between user 16 and the system. In some examples, interactive log 102 may also present summarized information in a text format for any results or visualizations presented to the user. In some examples, interactive log 102 may also present further analysis options that the user can select.

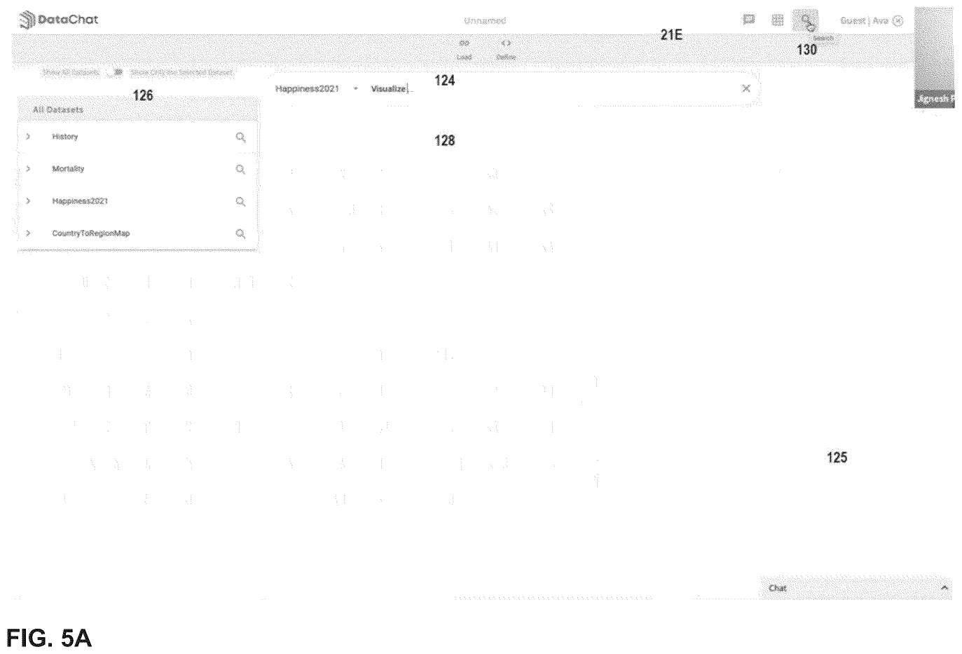

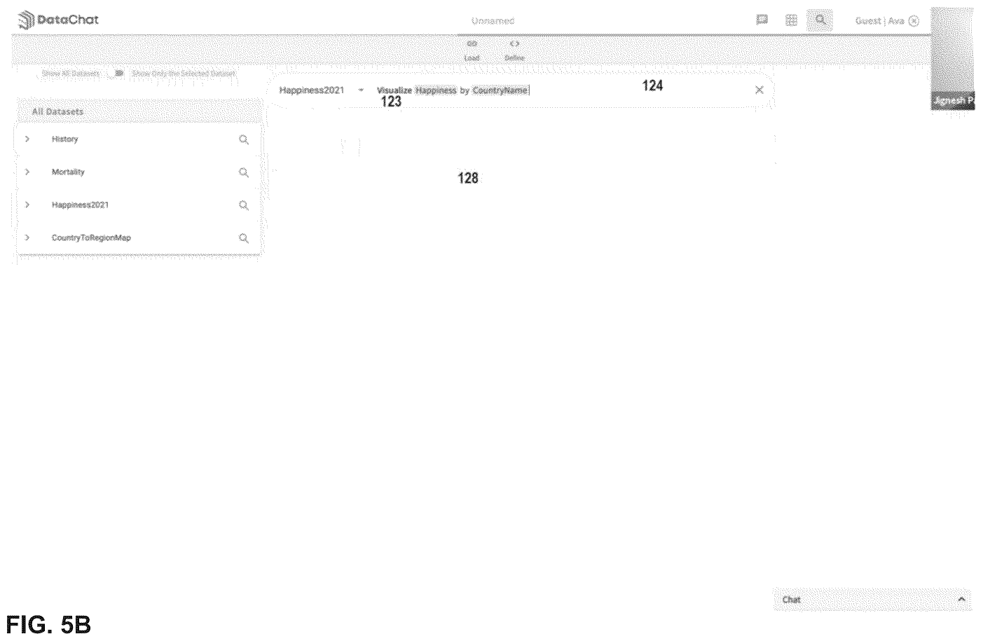

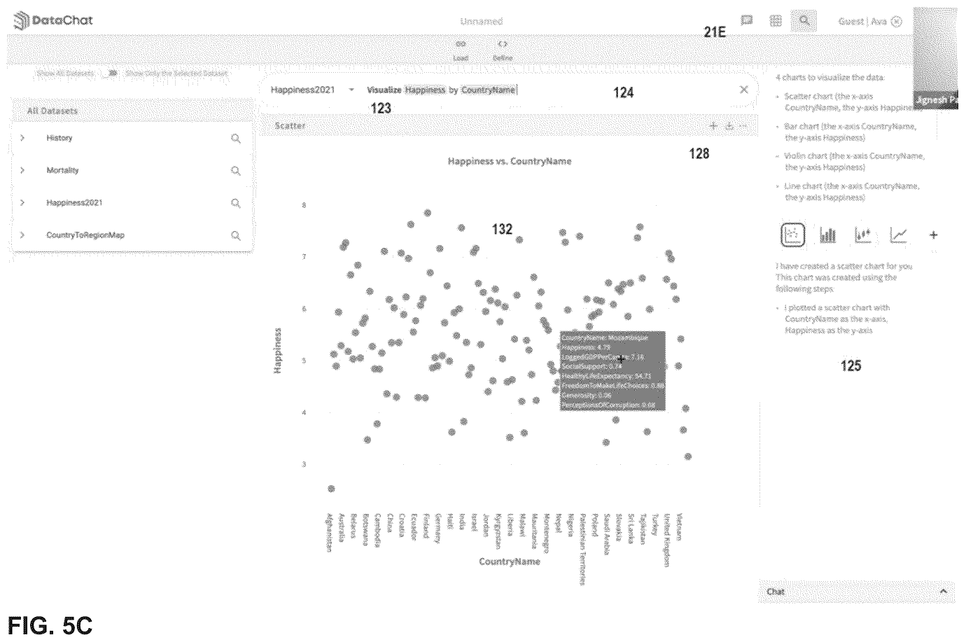

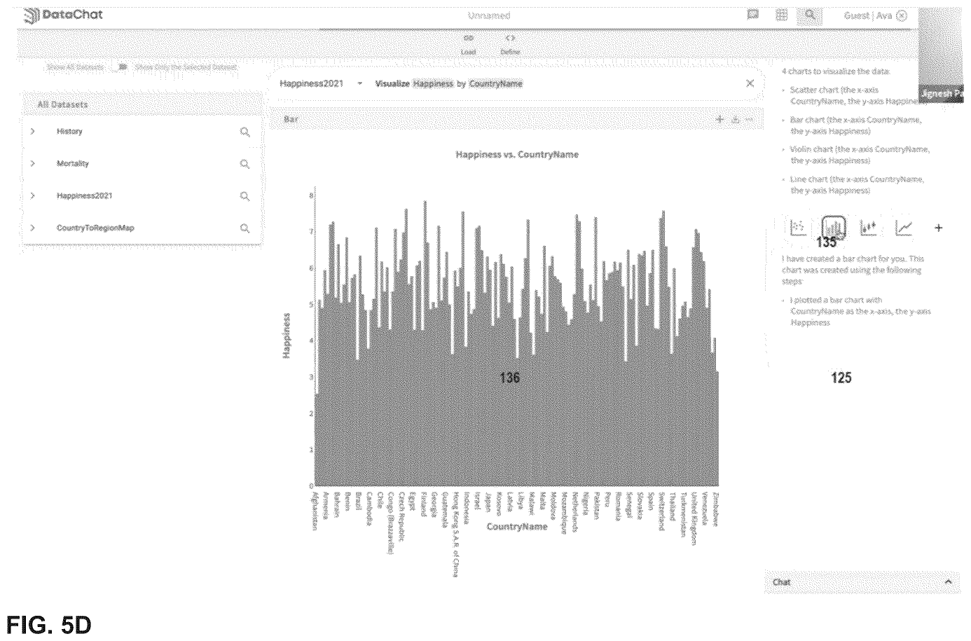

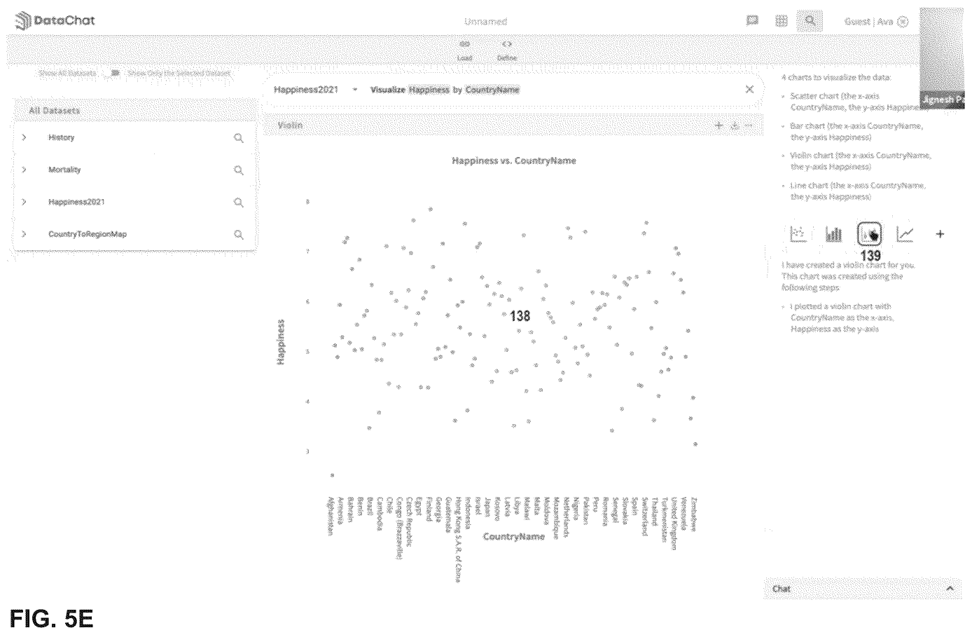

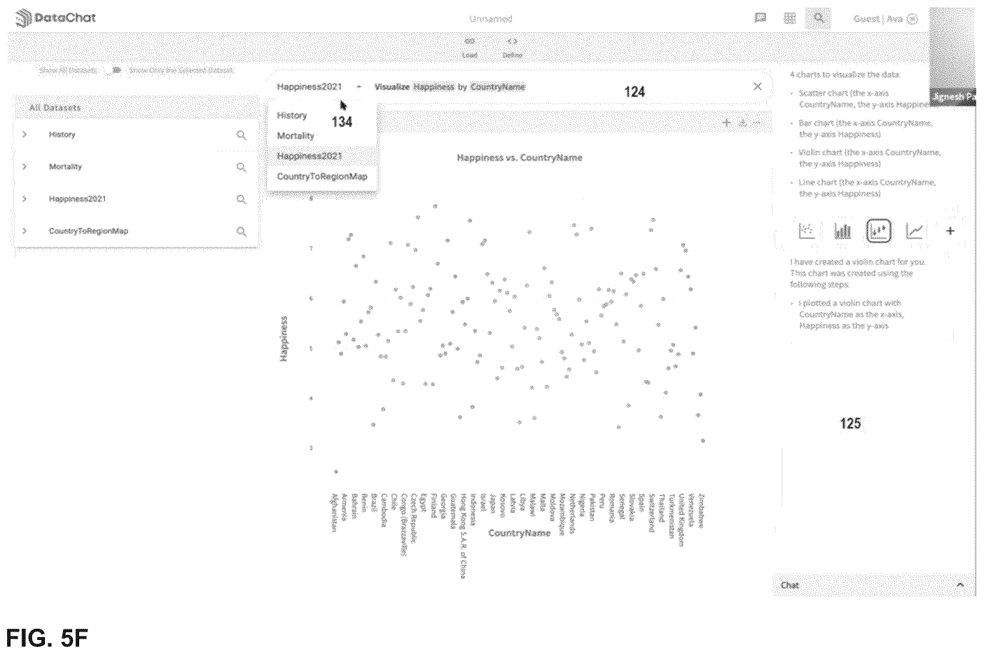

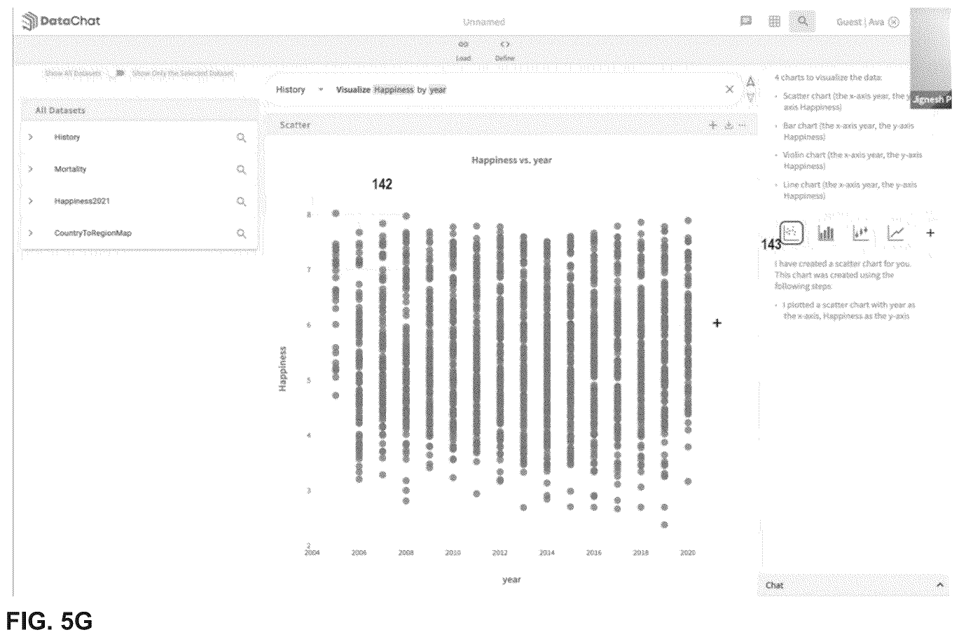

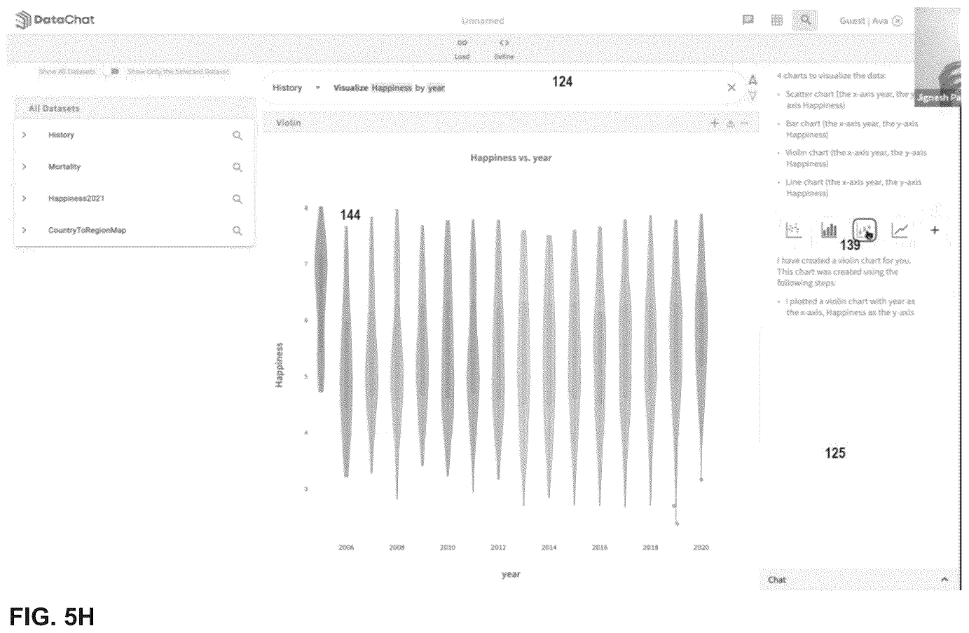

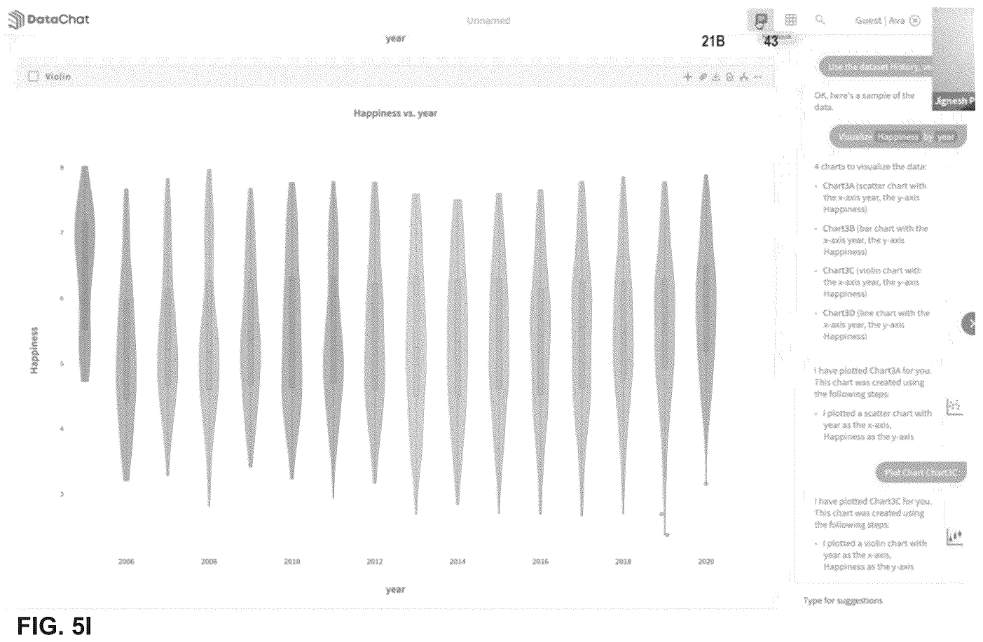

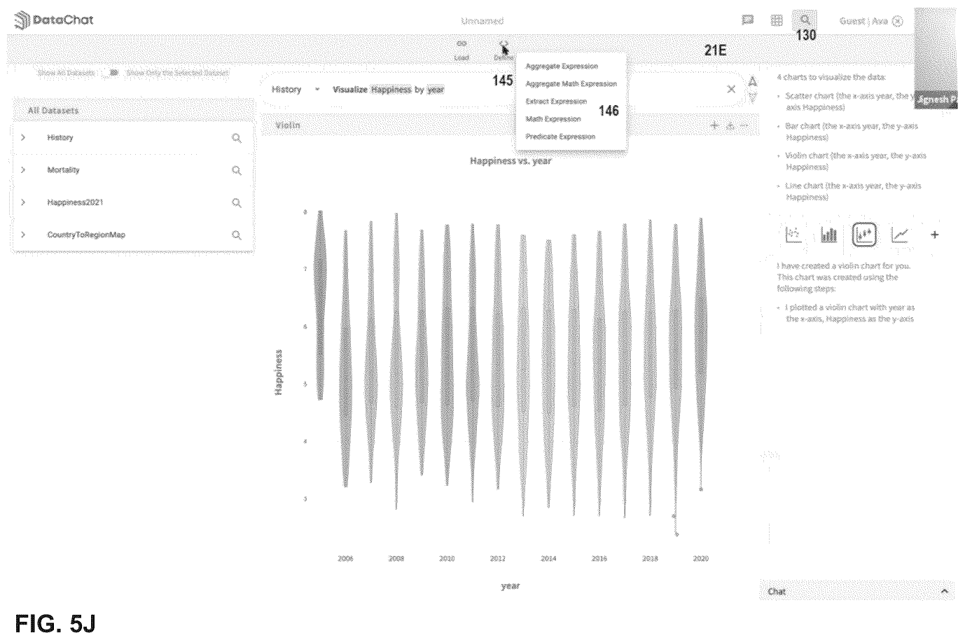

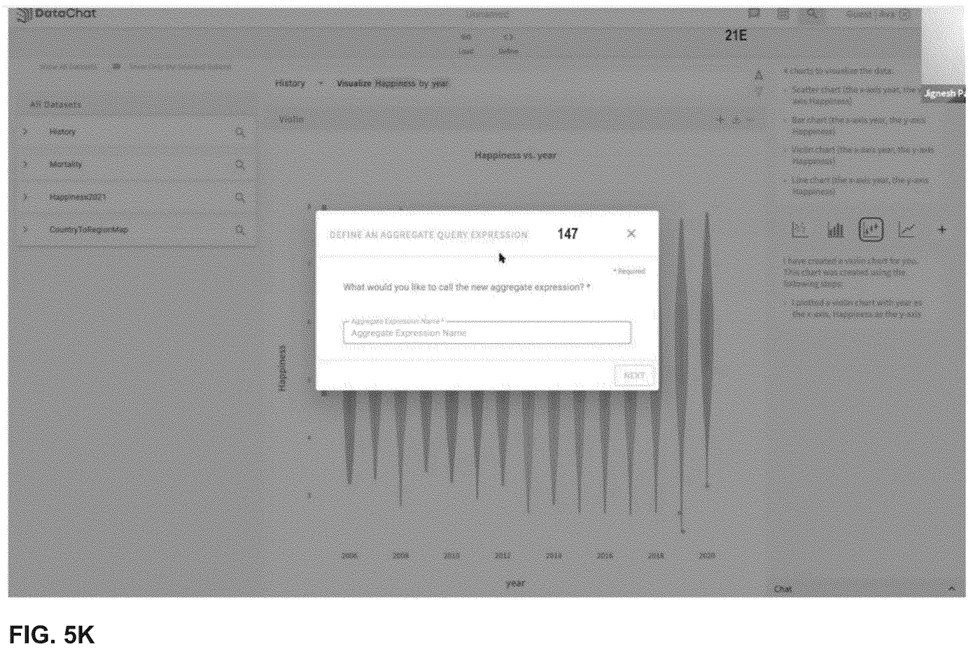

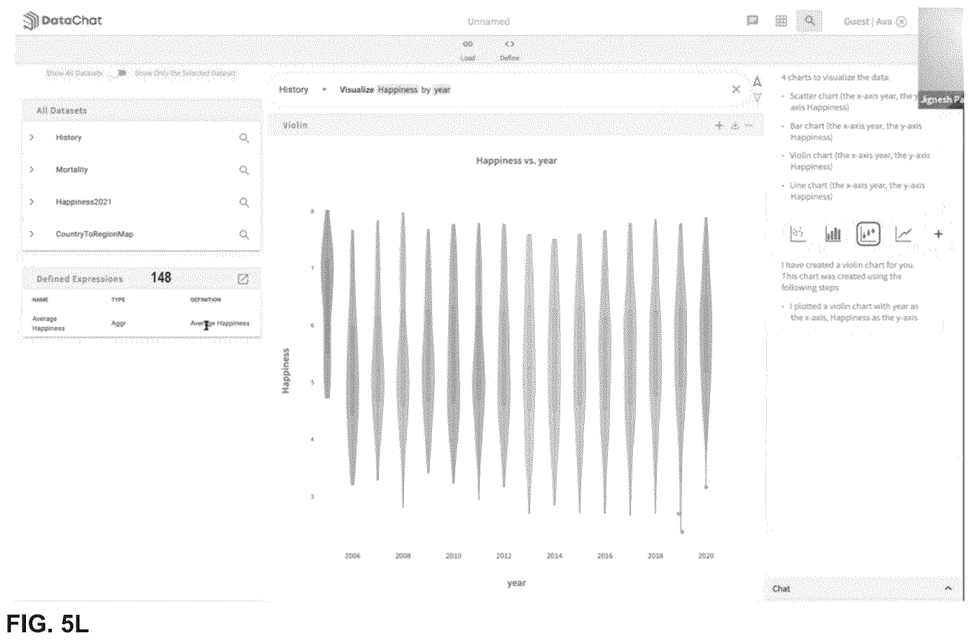

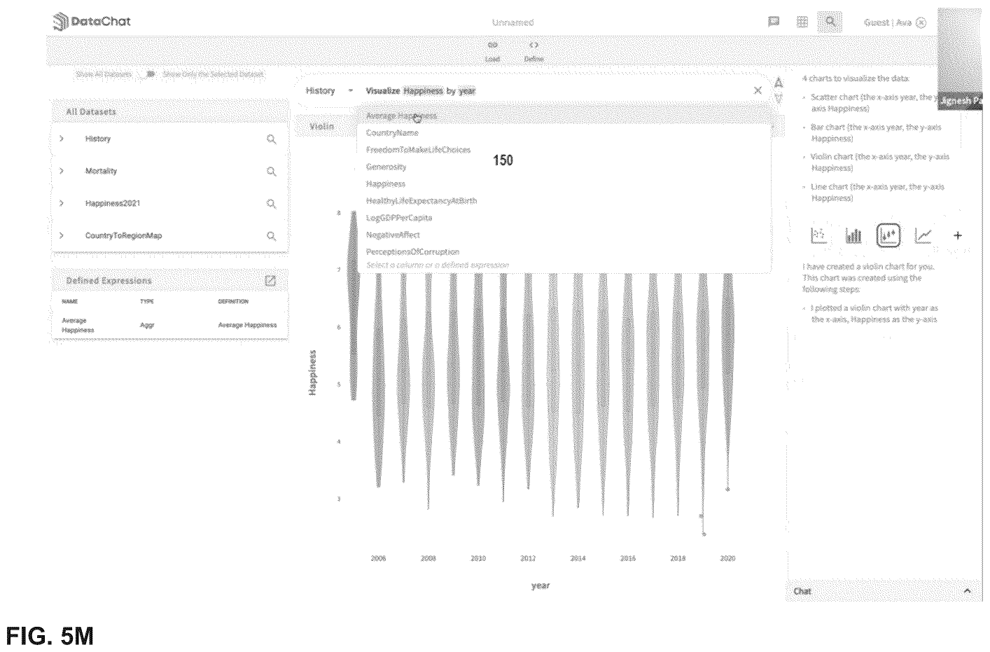

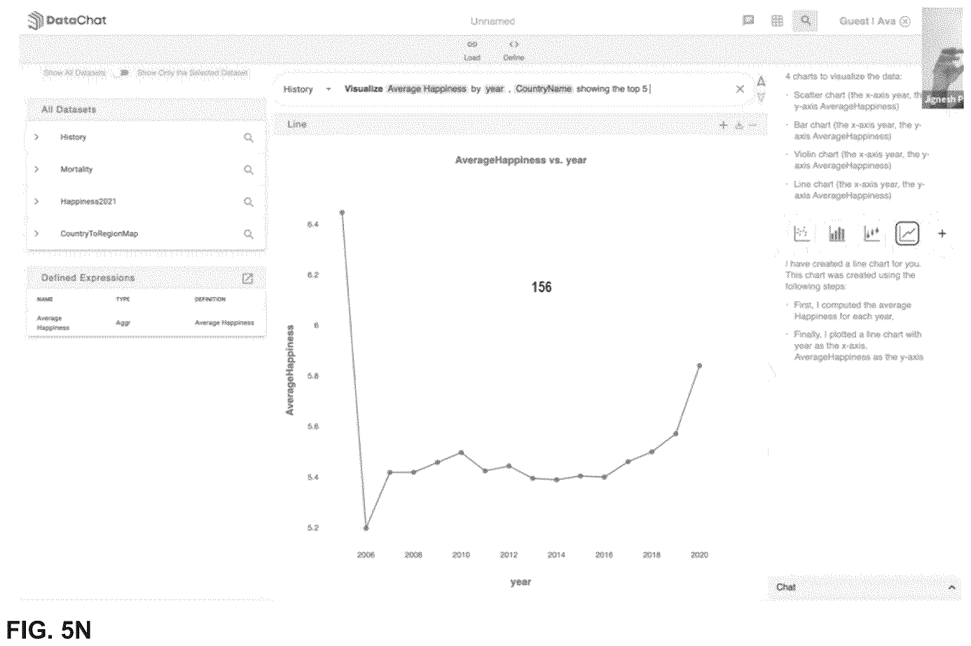

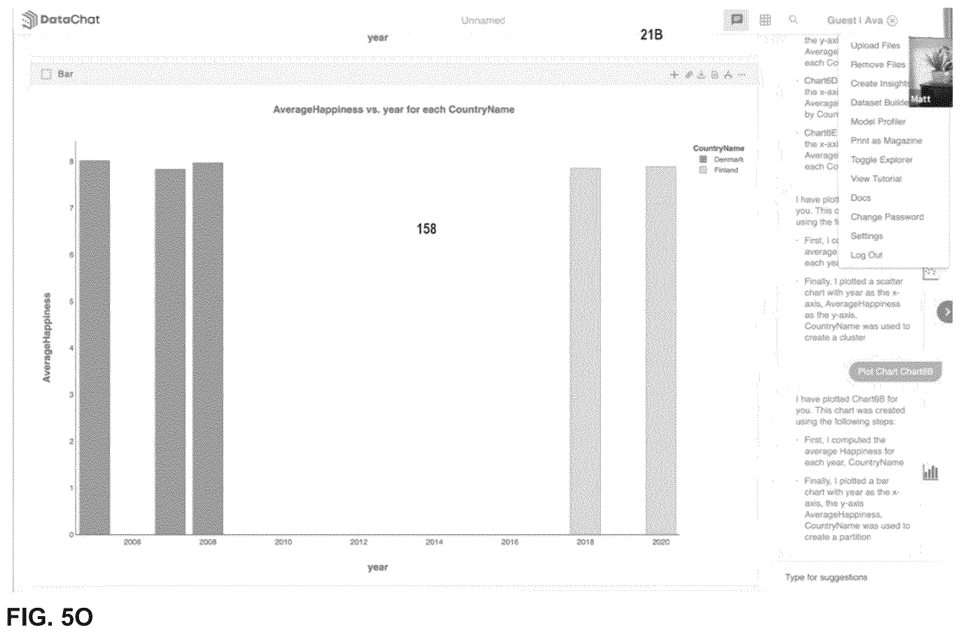

FIGS. 5A-5O are diagrams illustrating interface 21E that represents a search view presented by interface unit 20 of host device 12 that facilitates data analytics via general chatbot interface application 100A shown in FIG. 2 in accordance with various aspects of the CNLP techniques described in this disclosure. As described herein and shown throughout FIGS. 5A-5O, the search view may be considered another aspect of the user interface presented by application 100A that allows one or more users to quickly and efficiently visualize data through simple inputs that the system can interpret via natural language processing algorithms. For example, the search view may provide, via a first portion of the user interface (e.g., a first frame), an interactive search bar that allows one or more users to express intents via natural language. The search view may also include a second portion (e.g., a second frame) that presents a historical log of previous inputs and responses from the natural language processing engine, which again allows the one or more users to quickly assess how the results and/or responses were derived. The search view may also include a third portion (e.g., a third frame) that presents a graphical representation of the results provided responsive to any inputs. The search view may also include a fourth portion (e.g., a fourth frame) that presents the one or more datasets that the one or more users can analyze or visualize. Throughout the examples provided by FIGS. 5A-5O, the second and third portions of the search view user interface are separately scrollable but coupled such that interactions in either the second and third portions of the search view user interface synchronize the second and third portions of the search view user interface.

In some examples, the first portion of the search view user interface is located above the third portion of the search view user interface, the second portion of the search view user interface is located along a right boundary of the first and third portions of the search view user interface, and the fourth portion of the search view user interface is located along a left boundary of the first and third portions of the search view user interface.

In other words, rather than presenting a user interface in which users may have to perform multiple steps to generate visualizations, the search view user interface allows users to provide only simple commands or queries to the system to generate visualizations. The search view user interface, similar to the notebook view and spreadsheet view user interfaces, employs natural language processing that may allow users to interact with the system more easily and understand results produced by the system more intuitively. Additionally, when a user decides to transition from the notebook view user interface to the search view user interface or vice versa, all of the sentences or “recipes” that were used to interact with the system included in the historical log as well as all of the graphical representations of the results will be reproduced and/or translated onto either user interface. Thus, users can toggle between the search view user interface and the notebook view user interface and still see the same information. Additionally, the search view user interface may enable more visual (e.g., right-brain predominant) users to create complicated visual representations of the multi-dimensional data that would otherwise be difficult and time consuming. The search view may also allow users to easily change the format for graphical representations of the multi-dimensional data (e.g., the graphical representation can easily change from a line chart to a bubble chart, graph, etc.).

In the example of FIG. 5A, interface unit 20 has presented interface 21E that represents a search view that displays interactive search bar 124, results presentation portion 128, interactive log 125, and dataset table element 126 that displays all datasets user 16 can visualize. User 16 may select a search view button 130 and interface unit 20 may generate interface 21E to include interactive search bar 124, results presentation portion 128, interactive log 25, and dataset table element 126, in which interface unit 20 may provide interface 21E to user 16 via client 30. Similar to interactive text box 48 of FIG. 3A, interactive search bar 124 may automatically perform an autocomplete operation to facilitate entry of the current input. Interactive search bar 124 may limit a number of autocomplete recommendations to a threshold number of recommendations. Interactive search bat 124 may limit the number of recommendations to reduce clutter and facilitate user 16 in selecting a recommendation that is most likely to be useful to user 16. User interface 21E may prioritize recommendations based on preferences set by user 16, recency of accessing a various file, or any other priority-based algorithm (including machine-learning or other artificial intelligent priority and/or ranking algorithms).

FIG. 5B displays another view of FIG. 5A in which user 16 has selected the HAPPINESS2021 dataset and has entered input 123 specifying “Visualize Happiness by CountryName” into interactive search bar 124. In response to user 16 entering input 123, server 28 may interface with corresponding execution platform 26 to obtain results 25 that are presented in results presentation portion 128.

FIG. 5C displays another view of FIG. 5B in which server 28 has responded to input 123 provided by user 16 in interactive search bar 124. In the example of FIG. 5C, server 28 has interfaced with corresponding execution platform 26 to obtain results 25 presented as scatter plot 132 in results presentation portion 128. In the example of FIG. 5C, scatter plot 132 displays a scatter plot with “Happiness” on the y-axis and “CountryName” on the x-axis. FIG. 5C also includes interactive log 125 that records and displays the steps or operations performed by application 100A to produce scatter plot 132 in response to user 16 entering input 123.

FIG. 5D displays another view of FIG. 5C in which user 16 has selected bar chart visualization button 135 presented by application 100A in interactive log 125. As described in previous examples, application 100A may present further analysis options via interactive log 125 or another chat portion of the interface that user 16 can select. Further, application 100A may rank charts generated in the search view based on the optimal ways to visualize the information from the selected dataset. User 16 can search through the data and generated visualizations and decide their preferred visualization. In the example of FIG. 5D, in response to user 16 selecting bar chart visualization button 135, server 28 interfaces with corresponding execution platform 26 to obtain results 25 that are presented as bar chart 136 in results presentation portion 128. Bar chart 136, in this example, contains the same information presented in scatter plot 132 of FIG. 5C.

FIG. 5E displays another view of FIG. 5D in which user 16 has selected violin chart visualization button 139 presented by application 100A in interactive log 125. In the example of FIG. 5D, in response to user 16 selecting violin chart visualization button 139, server 28 interfaces with corresponding execution platform 26 to obtain results 25 that are presented as violin chart 138 in results presentation portion 128. Violin chart 138, in this example, contains the same information presented in scatter plot 132 of FIG. 5C and bar chart 136 of FIG. 5D.

FIG. 5F displays another view of FIG. 5E in which user 16 has elected to change the selected dataset in interactive search bar 124. In the example of FIG. 5E, user 16 selects dropdown element 134 that enables user 16 to choose a different dataset, such as the History dataset, to visualize.

FIG. 5G displays another view of FIG. 5F in which user 16 has entered input specifying “Visualize Happiness by year” into interactive search bar 124. In the example of FIG. 5G, user 16 has also selected scatter chart visualization button 143 presented by application 100A in interactive log 125. In the example of FIG. 5G, in response to user 16 selecting scatter chart visualization button 143, server 28 interfaces with corresponding execution platform 26 to obtain results 25 that are presented as scatter chart 142 in results presentation portion 128. In the example of FIG. 5G, scatter chart 142 displays a scatter chart with “Happiness” on the y-axis and “year” on the x-axis.

FIG. 5H displays another view of FIG. 5G in which user 16 has selected violin chart visualization button 139 presented by application 100A in interactive log 125. In the example of FIG. 5H, in response to user 16 selecting violin chart visualization button 139, server 28 interfaces with corresponding execution platform 26 to obtain results 25 that are presented as violin chart 144 in results presentation portion 128. In the example of FIG. 5H, violin chart 144 displays a violin chart that contains the same information presented in scatter chart 142 of FIG. 5G.

FIG. 5I displays another view of FIG. 5H in which user 16 has selected notebook button 43. As described previously, user 16 may switch between the various application 100A interfaces, wherein the interactions, tasks, conversations, etc. between user 16 and the system can be reproduced or translated into various viewing formats. For example, in the example of FIG. 5I, in response to user 16 selecting notebook button 43, interface unit 20 may generate interface 21B, or the notebook view, that includes elements of interface 21E, or the search view, in a different configuration.

FIG. 5J displays another view of FIG. 5I in which user 16 has switched back to interface 21E, or the search view, by selecting search view button 130 and has hovered over “Define” operation button 145. In the example of FIG. 5J, in response to user 16 hovering over “Define” operation button 145, interface 21E generated popup element 146 that displays various operations that application 100A can perform, such as “Aggregate Expression”, “Aggregate Math Expression”, “Extract Expression”, “Math Expression”, and “Predicate Expression”. An “Extract Expression” may for example, limit dates included in a particular dataset to a particular quarter. A “Predicate Expression” may exclude data in a particular dataset (e.g., exclude all data before 2018). “Define” operation button 145 may also allow user 16 to define certain terms in accordance with the CNLP techniques described in this disclosure that are used frequently to perform various operations.

FIG. 5K displays another view of FIG. 5J in which user interface 21E has generated pop-up element 147 in response to user 16 selecting “Define” operation button 145. In the example of FIG. 5K, pop-up element 147 may allow user 16 to define and name an aggregate query expression. For example, user 16 may enter “Average Happiness” as an aggregate expression name. User 16 may then define the term “Average Happiness” and link it to a new column named “Average Happiness” in the selected History dataset.

FIG. 5L displays another view of FIG. 5J in which interface 21E includes table element 148. In the example of FIG. 5L, table element 148 may include all defined expressions generated by user 16, such as the “Average Happiness” aggregate expression that user 16 defined and named in the example of FIG. 5K. Table element 148 may include the name of the defined expression, the type of the expression, and the definition.

FIG. 5M displays another view of FIG. 5L in which interface 21E has generated drop-down element 150 to allow user 16 to select a column or defined expression to visualize. In the example of FIG. 5M, as a result of user 16 defining “Average Happiness” in FIG. 5K, the “Average Happiness” column is included in the list of drop-down items that can be visualized.

FIG. 5N displays another view of FIG. 5M in which user 16 has selected a line chart for visualization of “Average Happiness” by year and interface 21E has generated line chart element 156. In the example of FIG. 5N, user 16 has also entered “CountryName showing the top 5 . . . ” into interactive search bar 124. The input from user 16 may act similar to a web search query that does not require much structure. The user can, however, switch back to the notebook view to engage more fully (or more precisely and specifically) with the application.

FIG. 5O displays the results generated from user 16's input in FIG. 5N. In the example of FIG. 5O, user 16 has switched to the notebook view and interface 21B has generated bar chart element 158. As described herein, the input and/or results to and generated by the system are reproduced or translated between each user interface, allowing user 16 to toggle between the different user interfaces without losing any information.

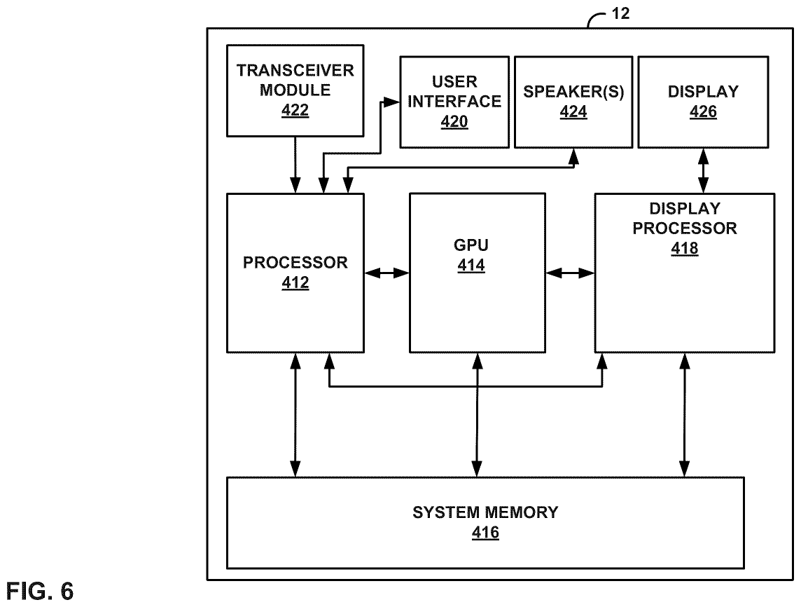

FIG. 6 is a block diagram illustrating example components of client device 12, which may substantially similar to client device 14 shown in the example of FIG. 1. In the example of FIG. 6, the device 12 includes a processor 412, a graphics processing unit (GPU) 414, system memory 416, a display processor 418, one or more integrated speakers 424, a display 426, a user interface 420, and a transceiver module 422. In examples where the client device 12 is a mobile device, the display processor 418 is a mobile display processor (MDP). In some examples, such as examples where the client device 12 is a mobile device, the processor 412, the GPU 414, and the display processor 418 may be formed as an integrated circuit (IC).

For example, the IC may be considered as a processing chip within a chip package and may be a system-on-chip (SoC). In some examples, two of the processors 412, the GPU 414, and the display processor 418 may be housed together in the same IC and the other in a different integrated circuit (i.e., different chip packages) or all three may be housed in different ICs or on the same IC. However, it may be possible that the processor 412, the GPU 414, and the display processor 418 are all housed in different integrated circuits in examples where the client device 12 is a mobile device.

Examples of the processor 412, the GPU 414, and the display processor 418 include, but are not limited to, one or more digital signal processors (DSPs), general purpose microprocessors, application specific integrated circuits (ASICs), field programmable logic arrays (FPGAs), or other equivalent integrated or discrete logic circuitry. The processor 412 may be the central processing unit (CPU) of the client device 12. In some examples, the GPU 414 may be specialized hardware that includes integrated and/or discrete logic circuitry that provides the GPU 414 with massive parallel processing capabilities suitable for graphics processing. In some instances, GPU 414 may also include general purpose processing capabilities, and may be referred to as a general-purpose GPU (GPGPU) when implementing general purpose processing tasks (i.e., non-graphics related tasks). The display processor 418 may also be specialized integrated circuit hardware that is designed to retrieve image content from the system memory 416, compose the image content into an image frame, and output the image frame to the display 426.

The processor 412 may execute various types of the applications. Examples of the applications include web browsers, e-mail applications, spreadsheets, video games, other applications that generate viewable objects for display, or any of the application types listed in more detail above. The system memory 416 may store instructions for execution of the applications. The execution of one of the applications 20 on the processor 412 causes the processor 412 to produce graphics data for image content that is to be displayed and the audio data that is to be played. The processor 412 may transmit graphics data of the image content to the GPU 414 for further processing based on and instructions or commands that the processor 412 transmits to the GPU 414.

The processor 412 may communicate with the GPU 414 in accordance with a particular application processing interface (API). Examples of such APIs include the DirectX® API by Microsoft®, the OpenGL® or OpenGL ES® by the Khronos group, and the OpenCL™; however, aspects of this disclosure are not limited to the DirectX, the OpenGL, or the OpenCL APIs, and may be extended to other types of APIs. Moreover, the techniques described in this disclosure are not required to function in accordance with an API, and the processor 412 and the GPU 414 may utilize any technique for communication.

The system memory 416 may be the memory for the source device 12. The system memory 416 may comprise one or more computer-readable storage media. Examples of the system memory 416 include, but are not limited to, a random-access memory (RAM), an electrically erasable programmable read-only memory (EEPROM), flash memory, or other medium that can be used to carry or store desired program code in the form of instructions and/or data structures and that can be accessed by a computer or a processor.

In some examples, the system memory 416 may include instructions that cause the processor 412, the GPU 414, and/or the display processor 418 to perform the functions ascribed in this disclosure to the processor 412, the GPU 414, and/or the display processor 418. Accordingly, the system memory 416 may be a computer-readable storage medium having instructions stored thereon that, when executed, cause one or more processors (e.g., the processor 412, the GPU 414, and/or the display processor 418) to perform various functions.

The system memory 416 may include a non-transitory storage medium. The term “non-transitory” indicates that the storage medium is not embodied in a carrier wave or a propagated signal. However, the term “non-transitory” should not be interpreted to mean that the system memory 416 is non-movable or that its contents are static. As one example, the system memory 416 may be removed from the client device 12 and moved to another device. As another example, memory, substantially similar to the system memory 416, may be inserted into the client devices 12. In certain examples, a non-transitory storage medium may store data that can, over time, change (e.g., in RAM).

The user interface 420 may represent one or more hardware or virtual (meaning a combination of hardware and software) user interfaces by which a user may interface with the client device 12. The user interface 420 may include physical buttons, switches, toggles, lights or virtual versions thereof. The user interface 420 may also include physical or virtual keyboards, touch interfaces-such as a touchscreen, haptic feedback, and the like.

The processor 412 may include one or more hardware units (including so-called “processing cores”) configured to perform all or some portion of the operations discussed above with respect to one or more of the various units/modules/etc. The transceiver module 422 may represent a unit configured to establish and maintain the wireless connection between the devices 12/14. The transceiver module 422 may represent one or more receivers and one or more transmitters capable of wireless communication in accordance with one or more wireless communication protocols.

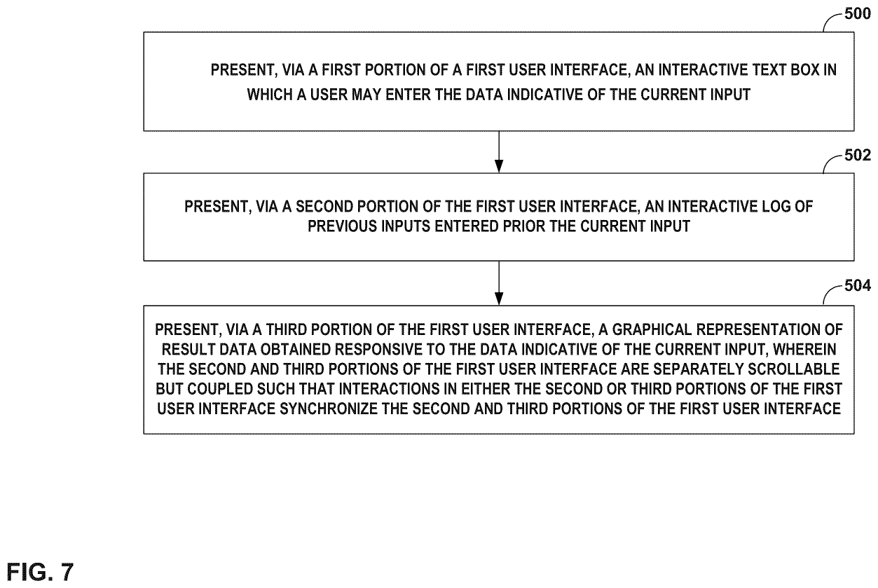

FIG. 7 is a flowchart illustrating example operation of the system of FIG. 1 in performing various aspects of the techniques described in this disclosure to enable more cohesive user interfaces for data analytic systems. Initially, client 30 may present, via the first frame (or other portion) of user interface 21B, an interactive text box in which user 16 may enter data representative of a current input (which may be referred to as the “current input 19” for ease of explanation) (500). The interactive text box may provide suggestions (via, as one example) an expanding suggestion pane that extends above the interactive text box to facilitate user 16 in entering current input 19).

Client 30 may present, via the second frame (or other portion) of user interface 21B, an interactive log of previous inputs (which may be denoted as “previous inputs 19”) entered prior to current input 19 (502). The first frame and second frame of user interface 21B may accommodate user 16 when user 16 represents a user having left-brained predominance, as the first frame and second frame of user interface 21B provide a more logical defined capability with expressing natural language utterances that directly generate results 25 using keywords and other syntax to which predominantly left-brain users predominantly relate.

Client 30 may further present, via the third frame of user interface 21B, a graphical representation of result data 25 obtained responsive to current input 19, where the second portion of user interface 21B and the third portion of user interface 21B are separately scrollable but coupled as described in more detail above (504). This third frame of user interface 21B may accommodate user 16 when user 16 represents a user having right-brained predominance, as the third frame of user interface 21B provides a more graphical/visual/artistic capability with expressing results 25 using visual representations of results 25 (e.g., charts, graphs, plots, etc.) that may represent multi-dimensional data (which may also be referred to as “multi-dimensional datasets” and as such may be referred to as “multi-dimensional data 25” or “multi-dimensional datasets 25”). As described in more detail above, the second and third frames of user interface 21B are separately scrollable but coupled such that interactions in either the second or third portions of user interface 21B synchronize the second and third portions of user interface 21B.

In this respect, various aspect of the techniques described in this disclosure may facilitate better interactions with respect to performing data analytics while also removing clutter and other distractions that may distract from understanding results 25 provided by data analytic systems, such as data analytic system 10. As a result, data analytic system 10 may operate more efficiently, as users 16 are able to more quickly understand results 25 without having to enter additional inputs and/or perform additional interactions with data analytic system 10 to understand presented results 25. By potentially reducing such inputs and/or interactions, data analytic system 10 may 10 may conserve various computing resources (e.g., processing cycles, memory space, memory bandwidth, etc.) along with power consumption consumed by such computing resources, thereby improving operation of data analytic systems themselves.

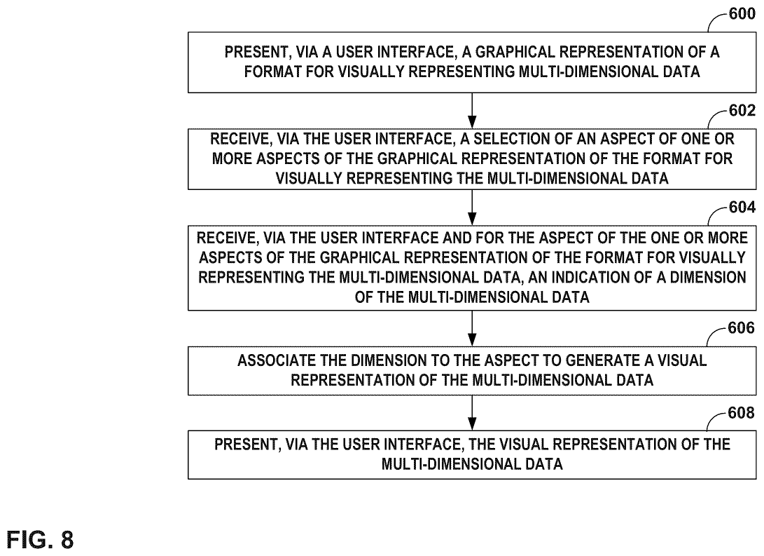

FIG. 8 is a flowchart illustrating another example operation of the system of FIG. 1 in performing various aspects of the techniques described in this disclosure to enable more cohesive user interfaces for data analytic systems. Initially, client 30 may 30 may present, via user interface 21 (which may include the various frames discussed throughout this disclosure), a graphical representation of a format for visually representing multi-dimensional data 25 (600). The format may change based on the particular visual representation of multi-dimensional data 25. For example, a bubble plot may include an x-axis, a y-axis, a bubble color, a bubble size, a slider, etc. As another example, a bar chart may include an x-axis, a y-axis, a bar color, a bar size, a slider, etc. In any event, the graphical representation may present a generic representation of a type of visual representation of multi-dimensional data 25, such as a generic bubble plot, a generic bar chart, or a generic graphical representation of any type of visual representation of multi-dimensional data 25.

User 16 may then interact with this general graphical representation of the visual representation of multi-dimensional data 25 to select one or more aspects (which may be another way to refer to the x-axis, y-axis, bubble color, bubble size, slider, or any other aspect of the particular type of visual representation of multi-dimensional data 25 that user 16 previously selected). As such, client 30 may receive, via user interface 21, the selection of an aspect of one or more aspects of the graphical representation of the format for visually representing multi-dimensional data 25 (602).

After selecting the aspect, user 16 may interface with client 30, via user interface 21, to select a dimension of multi-dimensional data 25 that should be associated with the selected aspect. Client 30 may then receive, via user interface 30 and for the aspect of the one or more aspects of the graphical representation of the format for visually representing multi-dimensional data 25, an indication of the dimension of the one or more dimensions of multi-dimensional data 25 (604).

Client 30 may next associate the dimension to the aspect to generate a visual representation of multi-dimensional data 25 (e.g., in the form of a bar chart, a line chart, an area chart, a gauge, a radar chart, a bubble plot, a scatter plot, a graph, a pie chart, a density map, a Gantt Chart, and a treemap. or any other type of plot, chart, graph or other visual representation) (606). Client 30 may proceed to present, via user interface 21, the visual representation of multi-dimensional data 25 (608).

As such, various aspects of the techniques described in this disclosure may facilitate generation of visual representations of multi-dimensional data 25 via graphical representations of the format for such visual representations, which may enable more visual (e.g., right-brain predominant) users to create complicated visual representations of the multi-dimensional data that would otherwise be difficult and time consuming (e.g., due to unfamiliarity with natural language utterances required to generate the visual representations). By reducing interactions while also explaining the corresponding natural language input alongside the visual representation of multi-dimensional data 25, data analytics system 10 may again operate more efficiently, as users 16 are able to more quickly understand results 25 without having to enter additional inputs and/or perform additional interactions with data analytic system 10 in an attempt to visualize multi-dimensional data 25 (which may also be referred to as a “result 25”). By potentially reducing such inputs and/or interactions, data analytic system 10 may conserve various computing resources (e.g., processing cycles, memory space, memory bandwidth, etc.) along with power consumption consumed by such computing resources, thereby improving operation of data analytic systems themselves.

In this way, various aspects of the techniques may enable the following clauses:

Clause 1A. A device configured to process data indicative of a current input, the device comprising: a memory configured to store one or more datasets including multi-dimensional data; one or more processors configured to: present, via a first portion of a first user interface, an interactive text box in which a user may enter the data indicative of the current input; present, via a second portion of the first user interface, an interactive log of previous inputs entered prior the current input; present, via a third portion of the first user interface, a graphical representation of result data obtained responsive to the data indicative of the current input; present, via a first portion of a second user interface, the interactive log presented by the second portion of the first user interface; present, via a second portion of the second user interface, the graphical representation of result data presented by the third portion of the first user interface; present, via a third portion of the second user interface, the one or more datasets; present, via a fourth portion of the second user interface, at least a portion of the multi-dimensional data included in the one or more datasets; present, via a first portion of a third user interface, an interactive search bar in which a user may enter the data indicative of the current input; present, via a second portion of the third user interface, an interactive log of previous inputs entered prior the current input; present, via a third portion of the third user interface, a graphical representation of result data obtained responsive to the data indicative of the current input; and present, via a fourth portion of the third user interface, the one or more datasets, wherein the second and third portions of the first user interface are separately scrollable but coupled such that interactions in either the second or third portions of the first user interface synchronize the second and third portions of the first user interface, wherein the first and second portions of the second user interface are separately scrollable but coupled such that interactions in either the first or second portions of the second user interface synchronize the first and second portions of the second user interface, and wherein the second, and third portions of the third user interface are separately scrollable but coupled such that interactions in either the second or third portions of the third user interface synchronize the second and third portions of the third user interface; and a memory configured to store the data indicative of the current input.

Clause 2A. The device of clause 1A, wherein the one or more processors are further configured to: present, via the first, second, or third user interface, a user interface indication that allows a user to transition between the first, second, and third user interfaces; and transition, responsive to receiving an indication that the user interface indication has been selected by the user, the first, second, or third user interface into the first, second, or third user interface.

Clause 3A. The device of clause 2A, wherein the interactive log of previous inputs entered prior the current input the graphical representation of result data obtained responsive to the data indicative of the current input are reproduced when the one or more processors transition the first, second, or third user interface into the first, second, or third user interface.

Clause 4A. The device of clause 1A, wherein the second portion of the first user interface is located above the first portion of the first user interface, and wherein the first portion of the first user interface and the second portion of the first user interface are located along a right boundary of the third portion of the first user interface.

Clause 5A. The device of clause 1A, wherein the second portion of the second user interface is located above the first portion of the second user interface, wherein the third portion of the second user interface is located above the second portion of the second user interface, and wherein the first, second, and third portions of the second user interface are located along a right boundary of the fourth portion of the second user interface.

Clause 6A. The device of clause 1A, wherein the first portion of the third user interface is located above the third portion of the third user interface, wherein the second portion of the third user interface is located along a right boundary of the first and third portions of the third user interface, and wherein the fourth portion of the third user interface is located along a left boundary of the first and third portions of the third user interface.

Clause 7A. The device of clause 1A, wherein the interactive text box and interactive search bar automatically perform an autocomplete operation to facilitate entry of the data indicative of the current input.

Clause 8A. The device of clause 7A, wherein the interactive text box limits a number of recommendations suggested during the autocomplete operation to a threshold number of recommendations.

Clause 9A. The device of clause 1A, wherein the graphical representation of result data includes a bar chart, a line chart, a violin chart, and a scatter chart.

Clause 10A. The device of clause 9A, wherein the one or more processors are configured to present the option to edit the graphical representation of result data.

Clause 11A. A method of processing data indicative of a current input, the method comprising: presenting, via a first portion of a first user interface, an interactive text box in which a user may enter the data indicative of the current input; presenting, via a second portion of the first user interface, an interactive log of previous inputs entered prior the current input; presenting, via a third portion of the first user interface, a graphical representation of result data obtained responsive to the data indicative of the current input; presenting, via a first portion of a second user interface, the interactive log presented by the second portion of the first user interface; presenting, via a second portion of the second user interface, the graphical representation of result data presented by the third portion of the first user interface; presenting, via a third portion of the second user interface, the one or more datasets; presenting, via a fourth portion of the second user interface, at least a portion of the multi-dimensional data included in the one or more datasets; presenting, via a first portion of a third user interface, an interactive search bar in which a user may enter the data indicative of the current input; presenting, via a second portion of the third user interface, an interactive log of previous inputs entered prior the current input; presenting, via a third portion of the third user interface, a graphical representation of result data obtained responsive to the data indicative of the current input; and presenting, via a fourth portion of the third user interface, the one or more datasets, wherein the second and third portions of the first user interface are separately scrollable but coupled such that interactions in either the second or third portions of the first user interface synchronize the second and third portions of the first user interface, wherein the first and second portions of the second user interface are separately scrollable but coupled such that interactions in either the first or second portions of the second user interface synchronize the first and second portions of the second user interface, and wherein the second, and third portions of the third user interface are separately scrollable but coupled such that interactions in either the second or third portions of the third user interface synchronize the second and third portions of the third user interface.

Clause 12A. The method of clause 11A, further comprising: presenting, via the first, second, or third user interface, a user interface indication that allows a user to transition between the first, second, and third user interfaces; and transitioning, responsive to receiving an indication that the user interface indication has been selected by the user, the first, second, or third user interface into the first, second, or third user interface.

Clause 13A. The method of clause 12A, wherein the interactive log of previous inputs entered prior the current input the graphical representation of result data obtained responsive to the data indicative of the current input are reproduced when the one or more processors transition the first, second, or third user interface into the first, second, or third user interface.

Clause 14A. The method of clause 11A, wherein the second portion of the first user interface is located above the first portion of the first user interface, and wherein the first portion of the first user interface and the second portion of the first user interface are located along a right boundary of the third portion of the first user interface.

Clause 15A. The method of clause 11A, wherein the second portion of the second user interface is located above the first portion of the second user interface, wherein the third portion of the second user interface is located above the second portion of the second user interface, and wherein the first, second, and third portions of the second user interface are located along a right boundary of the fourth portion of the second user interface.

Clause 16A. The method of clause 11A, wherein the first portion of the third user interface is located above the third portion of the third user interface, wherein the second portion of the third user interface is located along a right boundary of the first and third portions of the third user interface, and wherein the fourth portion of the third user interface is located along a left boundary of the first and third portions of the third user interface.

Clause 17A. The method of clause 11A, wherein the interactive text box and interactive search bar automatically perform an autocomplete operation to facilitate entry of the data indicative of the current input.

Clause 18A. The method of clause 17A, wherein the interactive text box limits a number of recommendations suggested during the autocomplete operation to a threshold number of recommendations.

Clause 19A. The method of clause 11A, wherein the graphical representation of result data includes a bar chart, a line chart, a violin chart, and a scatter chart.

Clause 20A. The method of clause 19A, wherein the one or more processors are configured to present the option to edit the graphical representation of result data.

Clause 21A. A non-transitory computer-readable storage medium having instructions stored thereon that, when executed, cause one or more processors to: present, via a first portion of a first user interface, an interactive text box in which a user may enter the data indicative of the current input; present, via a second portion of the first user interface, an interactive log of previous inputs entered prior the current input; present, via a third portion of the first user interface, a graphical representation of result data obtained responsive to the data indicative of the current input; present, via a first portion of a second user interface, the interactive log presented by the second portion of the first user interface; present, via a second portion of the second user interface, the graphical representation of result data presented by the third portion of the first user interface; present, via a third portion of the second user interface, the one or more datasets; present, via a fourth portion of the second user interface, at least a portion of the multi-dimensional data included in the one or more datasets; present, via a first portion of a third user interface, an interactive search bar in which a user may enter the data indicative of the current input; present, via a second portion of the third user interface, an interactive log of previous inputs entered prior the current input; present, via a third portion of the third user interface, a graphical representation of result data obtained responsive to the data indicative of the current input; and present, via a fourth portion of the third user interface, the one or more datasets, wherein the second and third portions of the first user interface are separately scrollable but coupled such that interactions in either the second or third portions of the first user interface synchronize the second and third portions of the first user interface, wherein the first and second portions of the second user interface are separately scrollable but coupled such that interactions in either the first or second portions of the second user interface synchronize the first and second portions of the second user interface, and wherein the second, and third portions of the third user interface are separately scrollable but coupled such that interactions in either the second or third portions of the third user interface synchronize the second and third portions of the third user interface; and a memory configured to store the data indicative of the current input.

Clause 1B. A device configured to perform data analytics, the device comprising: a memory configured to store multi-dimensional data; and one or more processors configured to: present, via a user interface, a graphical representation of a format for visually representing the multi-dimensional data; receive, via the user interface, a selection of an aspect of one or more aspects of the graphical representation of the format for visually representing the multi-dimensional data; receive, via the user interface and for the aspect of the one or more aspects of the graphical representation of the format for visually representing the multi-dimensional data, an indication of a dimension of the multi-dimensional data; associate the dimension to the aspect to generate a visual representation of the multi-dimensional data; and present, via the user interface, the visual representation of the multi-dimensional data.

Clause 2B. The device of clause 1B, wherein the one or more processors are configured to, when configured to associate the dimension to the aspect, generate data indicative of an input that would have, when entered by a user, associated the dimension to the aspect to generate the visual representation of the multi-dimensional data; and wherein the one or more processors are further configured to present, via the user interface, the data indicative of the input.

Clause 3B. The device of any combination of clauses 1B and 2B, wherein the one or more processors are further configured to process the dimension of the multi-dimensional data to create a new dimension of the multi-dimensional data, and wherein the one or more processors are configured to, when configured to associate the dimension to the aspect, associate the new dimension to the aspect to generate the visual representation of the multi-dimensional data.

Clause 4B. The device of any combination of clauses 1B-3B, wherein the one or more processors are configured to, when configured to associate the dimension to the aspect: confirm that the association of the dimension to the aspect is compatible; and present, via the user interface and when the association of the dimension to the aspect is compatible, a preview of the visual representation of the multi-dimensional data.

Clause 5B. The device of clause 4B, wherein the one or more processors are configured to, when configured to associate the dimension to the aspect, present, via the user interface and when the association of the dimension to the aspect is not compatible, an indication that the association of the dimension to the aspect is not compatible, and an option to correct the association of the dimension to the aspect.

Clause 6B. The device of any combination of clauses 4B and 5B, wherein the one or more processors are configured to, when configured to present the preview of the visual representation of the multi-dimensional data, present an option to edit the visual representation of the multi-dimensional data.

Clause 7B. The device of clause 6B, wherein the one or more processors are configured to, when configured to present the option to edit the visual representation of the multi-dimensional data, present the option to edit one or more of a color, a title, text, and descriptors associated with the visual representation of the multi-dimensional data.

Clause 8B. The device of any combination of clauses 1B-7B, wherein the one or more processors are further configured to present, via the user interface, at least a portion of the multi-dimensional data in addition to the visual representation of the multi-dimensional data.

Clause 9B. The device of any combination of clauses 1B-8B, wherein the visual representation of the multi-dimensional data includes a bar chart, a line chart, an area chart, a gauge, a radar chart, a bubble plot, a scatter plot, a graph, a pie chart, a density map, a Gantt Chart, and a treemap.

Clause 10B. A method of performing data analytics, the method comprising: presenting, via a user interface, a graphical representation of a format for visually representing multi-dimensional data; receiving, via the user interface, a selection of an aspect of one or more aspects of the graphical representation of the format for visually representing the multi-dimensional data; receiving, via the user interface and for the aspect of the one or more aspects of the graphical representation of the format for visually representing the multi-dimensional data, an indication of a dimension of the multi-dimensional data; associating the dimension to the aspect to generate a visual representation of the multi-dimensional data; and presenting, via the user interface, the visual representation of the multi-dimensional data.

Clause 11B. The method of clause 10B, wherein associating the dimension to the aspect comprises generating data indicative of an input that would have, when entered by a user, associated the dimension to the aspect to generate the visual representation of the multi-dimensional data; and wherein the method further comprises presenting, via the user interface, the data indicative of the input.

Clause 12B. The method of any combination of clauses 10B and 11B, further comprising processing the dimension of the multi-dimensional data to create a new dimension of the multi-dimensional data, wherein associating the dimension to the aspect comprises associating the new dimension to the aspect to generate the visual representation of the multi-dimensional data.

Clause 13B. The method of any combination of clauses 10B-12B, wherein associating the dimension to the aspect comprises: confirming that the association of the dimension to the aspect is compatible; and presenting, via the user interface and when the association of the dimension to the aspect is compatible, a preview of the visual representation of the multi-dimensional data.

Clause 14B. The method of clause 13B, wherein associating the dimension to the aspect comprises presenting, via the user interface and when the association of the dimension to the aspect is not compatible, an indication that the association of the dimension to the aspect is not compatible, and an option to correct the association of the dimension to the aspect.

Clause 15B. The method of any combination of clauses 13B and 14B, wherein presenting the preview of the visual representation of the multi-dimensional data comprises presenting an option to edit the visual representation of the multi-dimensional data.

Clause 16B. The method of clause 15B, wherein presenting the option to edit the visual representation of the multi-dimensional data comprises presenting the option to edit one or more of a color, a title, text, and descriptors associated with the visual representation of the multi-dimensional data.

Clause 17B. The method of any combination of clauses 10B-16B, further comprising presenting, via the user interface, at least a portion of the multi-dimensional data in addition to the visual representation of the multi-dimensional data.

Clause 18B. The method of any combination of clauses 10B-17B, wherein the visual representation of the multi-dimensional data includes a bar chart, a line chart, an area chart, a gauge, a radar chart, a bubble plot, a scatter plot, a graph, a pie chart, a density map, a Gantt Chart, and a treemap.

Clause 19B. A non-transitory computer-readable storage medium having instructions stored thereon that, when executed, cause one or more processors to: present, via a user interface, a graphical representation of a format for visually representing multi-dimensional data; receive, via the user interface, a selection of an aspect of one or more aspects of the graphical representation of the format for visually representing the multi-dimensional data; receive, via the user interface and for the aspect of the one or more aspects of the graphical representation of the format for visually representing the multi-dimensional data, an indication of a dimension of the multi-dimensional data; associate the dimension to the aspect to generate a visual representation of the multi-dimensional data; and present, via the user interface, the visual representation of the multi-dimensional data.

Clause 1C. A device configured to process data indicative of a current input, the device comprising: a memory configured to store one or more datasets including multi-dimensional data; one or more processors configured to: present, via a first portion of a first user interface, an interactive text box in which a user may enter the data indicative of the current input; present, via a second portion of the first user interface, an interactive log of previous inputs entered prior the current input; and present, via a third portion of the first user interface, a graphical representation of result data obtained responsive to the data indicative of the current input, wherein the second and third portions of the first user interface are separately scrollable but coupled such that interactions in either the second or third portions of the first user interface synchronize the second and third portions of the first user interface; and a memory configured to store the data indicative of the current input.

Clause 2C. The device of clause 1C, wherein the second portion of the first user interface is located above the first portion of the first user interface, and wherein the first portion of the first user interface and the second portion of the first user interface are located along a right boundary of the third portion of the first user interface.

Clause 3C. The device of clause 1C, wherein the interactive text box automatically performs an autocomplete operation to facilitate entry of the data indicative of the current input.

Clause 4C. The device of clause 3C, wherein the interactive text box limits a number of recommendations suggested during the autocomplete operation to a threshold number of recommendations.

Clause 5C. The device of clause 1C, wherein the one or more processors are further configured to: present, via a first portion of a second user interface, the interactive log presented by the second portion of the first user interface; present, via a second portion of the second user interface, the graphical representation of result data presented by the third portion of the first user interface; present, via a third portion of the second user interface, the one or more datasets; and present, via a fourth portion of the second user interface, at least a portion of the multi-dimensional data included in the one or more datasets, wherein the first and second portions of the second user interface are separately scrollable but coupled such that interactions in either the first or second portions of the second user interface synchronize the first and second portions of the second user interface.

Clause 6C. The device of clause 5C, wherein the second portion of the second user interface is located above the first portion of the second user interface, wherein the third portion of the second user interface is located above the second portion of the second user interface, and wherein the first, second, and third portions of the second user interface are located along a right boundary of the fourth portion of the second user interface.

Clause 7C. The device of any combination of clauses 1C and 5C, wherein the one or more processors are further configured to: present, via a first portion of a third user interface, an interactive search bar in which a user may enter the data indicative of the current input; present, via a second portion of the third user interface, an interactive log of previous inputs entered prior the current input; present, via a third portion of the third user interface, a graphical representation of result data obtained responsive to the data indicative of the current input; and present, via a fourth portion of the third user interface, the one or more datasets, wherein the second, and third portions of the third user interface are separately scrollable but coupled such that interactions in either the second or third portions of the third user interface synchronize the second and third portions of the third user interface.

Clause 8C. The device of clause 7C, wherein the first portion of the third user interface is located above the third portion of the third user interface, wherein the second portion of the third user interface is located along a right boundary of the first and third portions of the third user interface, and wherein the fourth portion of the third user interface is located along a left boundary of the first and third portions of the third user interface.

Clause 9C. The device of clause 7C, wherein the interactive search bar automatically performs an autocomplete operation to facilitate entry of the data indicative of the current input.

Clause 10C. The device of clause 9C, wherein the interactive search bar limits a number of recommendations suggested during the autocomplete operation to a threshold number of recommendations.

Clause 11C. The device of any combination of clauses 1C-10C, wherein the one or more processors are further configured to: present, via the first, second, or third user interface, a user interface indication that allows a user to transition between the first, second, and third user interfaces; and transition, responsive to receiving an indication that the user interface indication has been selected by the user, the first, second, or third user interface into the first, second, or third user interface.

Clause 12C. The device of clause 11C, wherein the interactive log of previous inputs entered prior to the current input and the graphical representation of result data obtained responsive to the data indicative of the current input are reproduced when the one or more processors transition the first, second, or third user interface into the first, second, or third user interface.

Clause 13C. The device of any combination of clauses 1C-12C, wherein the graphical representation of result data includes a bar chart, a line chart, a violin chart, and a scatter chart.

Clause 14C. The device of clause 13C, wherein the one or more processors are configured to present the option to edit the graphical representation of result data.

Clause 15C. A method of processing data indicative of a current input, the method comprising: presenting, via a first portion of a first user interface, an interactive text box in which a user may enter the data indicative of the current input; presenting, via a second portion of the first user interface, an interactive log of previous inputs entered prior the current input; and presenting, via a third portion of the first user interface, a graphical representation of result data obtained responsive to the data indicative of the current input, wherein the second and third portions of the first user interface are separately scrollable but coupled such that interactions in either the second or third portions of the first user interface synchronize the second and third portions of the first user interface; and storing the data indicative of the current input in a memory.

Clause 16C. The method of clause 15C, wherein the second portion of the first user interface is located above the first portion of the first user interface, and wherein the first portion of the first user interface and the second portion of the first user interface are located along a right boundary of the third portion of the first user interface.

Clause 17C. The method of clause 15C, wherein the interactive text box automatically performs an autocomplete operation to facilitate entry of the data indicative of the current input.

Clause 18C. The method of clause 17C, wherein the interactive text box limits a number of recommendations suggested during the autocomplete operation to a threshold number of recommendations.

Clause 19C. The method of clause 15C, further comprising: presenting, via a first portion of a second user interface, the interactive log presented by the second portion of the first user interface; presenting, via a second portion of the second user interface, the graphical representation of result data presented by the third portion of the first user interface; presenting, via a third portion of the second user interface, the one or more datasets; and presenting, via a fourth portion of the second user interface, at least a portion of the multi-dimensional data included in the one or more datasets, wherein the first and second portions of the second user interface are separately scrollable but coupled such that interactions in either the first or second portions of the second user interface synchronize the first and second portions of the second user interface.

Clause 20C. The method of clause 19C, wherein the second portion of the second user interface is located above the first portion of the second user interface, wherein the third portion of the second user interface is located above the second portion of the second user interface, and wherein the first, second, and third portions of the second user interface are located along a right boundary of the fourth portion of the second user interface.

Clause 21C. The method of any combination of clauses 15C and 19C, further comprising: presenting, via a first portion of a third user interface, an interactive search bar in which a user may enter the data indicative of the current input; presenting, via a second portion of the third user interface, an interactive log of previous inputs entered prior the current input; presenting, via a third portion of the third user interface, a graphical representation of result data obtained responsive to the data indicative of the current input; and presenting, via a fourth portion of the third user interface, the one or more datasets, wherein the second, and third portions of the third user interface are separately scrollable but coupled such that interactions in either the second or third portions of the third user interface synchronize the second and third portions of the third user interface.

Clause 22C. The method of clause 21C, wherein the first portion of the third user interface is located above the third portion of the third user interface, wherein the second portion of the third user interface is located along a right boundary of the first and third portions of the third user interface, and wherein the fourth portion of the third user interface is located along a left boundary of the first and third portions of the third user interface.

Clause 23C. The method of clause 21C, wherein the interactive search bar automatically performs an autocomplete operation to facilitate entry of the data indicative of the current input.

Clause 24C. The method of clause 23C, wherein the interactive search bar limits a number of recommendations suggested during the autocomplete operation to a threshold number of recommendations.

Clause 25C. The method of any combination of clauses 15C-24C, further comprising: presenting, via the first, second, or third user interface, a user interface indication that allows a user to transition between the first, second, and third user interfaces; and transitioning, responsive to receiving an indication that the user interface indication has been selected by the user, the first, second, or third user interface into the first, second, or third user interface.

Clause 26C. The method of clause 25C, wherein the interactive log of previous inputs entered prior to the current input and the graphical representation of result data obtained responsive to the data indicative of the current input are reproduced when the one or more processors transition the first, second, or third user interface into the first, second, or third user interface.

Clause 27C. The method of any combination of clauses 15C-26C, wherein the graphical representation of the result data includes a bar chart, a line chart, a violin chart, and a scatter chart.

Clause 28C. The method of clause 27C, wherein the one or more processors are configured to present the option to edit the graphical representation of result data.

Clause 29C. A non-transitory computer-readable storage medium having instructions stored thereon that, when executed, cause one or more processors to: present, via a first portion of a first user interface, an interactive text box in which a user may enter the data indicative of the current input; present, via a second portion of the first user interface, an interactive log of previous inputs entered prior the current input; and present, via a third portion of the first user interface, a graphical representation of result data obtained responsive to the data indicative of the current input, wherein the second and third portions of the first user interface are separately scrollable but coupled such that interactions in either the second or third portions of the first user interface synchronize the second and third portions of the first user interface; and store the data indicative of the current input in a memory.

Clause 30C. The non-transitory computer-readable storage medium of clause 29C, wherein the one or more processors are further configured to: present, via a first portion of a second user interface, the interactive log presented by the second portion of the first user interface; present, via a second portion of the second user interface, the graphical representation of result data presented by the third portion of the first user interface; present, via a third portion of the second user interface, the one or more datasets; and present, via a fourth portion of the second user interface, at least a portion of the multi-dimensional data included in the one or more datasets, wherein the first and second portions of the second user interface are separately scrollable but coupled such that interactions in either the first or second portions of the second user interface synchronize the first and second portions of the second user interface.

Clause 31C. The non-transitory computer-readable storage medium of any combination of clauses 29C and 30C, wherein the one or more processors are further configured to: present, via a first portion of a third user interface, an interactive search bar in which a user may enter the data indicative of the current input; present, via a second portion of the third user interface, an interactive log of previous inputs entered prior the current input; present, via a third portion of the third user interface, a graphical representation of result data obtained responsive to the data indicative of the current input; and present, via a fourth portion of the third user interface, the one or more datasets, wherein the second, and third portions of the third user interface are separately scrollable but coupled such that interactions in either the second or third portions of the third user interface synchronize the second and third portions of the third user interface.

In each of the various instances described above, it should be understood that the devices 12/14 may perform a method or otherwise comprise means to perform each step of the method for which the devices 12/14 is described above as performing. In some instances, the means may comprise one or more processors. In some instances, the one or more processors may represent a special purpose processor configured by way of instructions stored to a non-transitory computer-readable storage medium. In other words, various aspects of the techniques in each of the sets of encoding examples may provide for a non-transitory computer-readable storage medium having stored thereon instructions that, when executed, cause the one or more processors to perform the method for which the devices 12/14 has been configured to perform.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media. Data storage media may be any available media that can be accessed by one or more computers or one or more processors to retrieve instructions, code and/or data structures for implementation of the techniques described in this disclosure. A computer program product may include a computer-readable medium.

Likewise, in each of the various instances described above, it should be understood that the client device 14 may perform a method or otherwise comprise means to perform each step of the method for which the client device 14 is configured to perform. In some instances, the means may comprise one or more processors. In some instances, the one or more processors may represent a special purpose processor configured by way of instructions stored to a non-transitory computer-readable storage medium. In other words, various aspects of the techniques in each of the sets of encoding examples may provide for a non-transitory computer-readable storage medium having stored thereon instructions that, when executed, cause the one or more processors to perform the method for which the client device 14 has been configured to perform.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some examples, the functionality described herein may be provided within dedicated hardware and/or software modules configured for encoding and decoding or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various aspects of the techniques have been described. These and other aspects of the techniques are within the scope of the following claims.

What is claimed is:

1. A device configured to process data indicative of a current input, the device comprising:
a memory configured to store one or more datasets including multi-dimensional data;
one or more processors configured to:
present, via a first portion of a first user interface, an interactive text box in which a user may enter the data indicative of the current input;
present, via a second portion of the first user interface, an interactive log of previous inputs entered prior the current input; and
present, via a third portion of the first user interface, a graphical representation of result data obtained responsive to the data indicative of the current input,
wherein the second and third portions of the first user interface are separately scrollable but coupled such that interactions in either the second or third portions of the first user interface synchronize the second and third portions of the first user interface; and
a memory configured to store the data indicative of the current input.

2. The device of claim 1,
wherein the second portion of the first user interface is located above the first portion of the first user interface, and
wherein the first portion of the first user interface and the second portion of the first user interface are located along a right boundary of the third portion of the first user interface.

3. The device of claim 1, wherein the interactive text box automatically performs an autocomplete operation to facilitate entry of the data indicative of the current input.

4. The device of claim 3, wherein the interactive text box limits a number of recommendations suggested during the autocomplete operation to a threshold number of recommendations.

5. The device of claim 1, wherein the one or more processors are further configured to:
present, via a first portion of a second user interface, the interactive log presented by the second portion of the first user interface;
present, via a second portion of the second user interface, the graphical representation of result data presented by the third portion of the first user interface;
present, via a third portion of the second user interface, the one or more datasets; and
present, via a fourth portion of the second user interface, at least a portion of the multi-dimensional data included in the one or more datasets,
wherein the first and second portions of the second user interface are separately scrollable but coupled such that interactions in either the first or second portions of the second user interface synchronize the first and second portions of the second user interface.

6. The device of claim 5,
wherein the second portion of the second user interface is located above the first portion of the second user interface,
wherein the third portion of the second user interface is located above the second portion of the second user interface, and
wherein the first, second, and third portions of the second user interface are located along a right boundary of the fourth portion of the second user interface.

7. The device of claim 1, wherein the one or more processors are further configured to:
present, via a first portion of a third user interface, an interactive search bar in which a user may enter the data indicative of the current input;
present, via a second portion of the third user interface, an interactive log of previous inputs entered prior the current input;
present, via a third portion of the third user interface, a graphical representation of result data obtained responsive to the data indicative of the current input; and
present, via a fourth portion of the third user interface, the one or more datasets, wherein the second, and third portions of the third user interface are separately scrollable but coupled such that interactions in either the second or third portions of the third user interface synchronize the second and third portions of the third user interface.

8. The device of claim 7,
wherein the first portion of the third user interface is located above the third portion of the third user interface,
wherein the second portion of the third user interface is located along a right boundary of the first and third portions of the third user interface, and
wherein the fourth portion of the third user interface is located along a left boundary of the first and third portions of the third user interface.

9. The device of claim 7, wherein the interactive search bar automatically performs an autocomplete operation to facilitate entry of the data indicative of the current input.

10. The device of claim 9, wherein the interactive search bar limits a number of recommendations suggested during the autocomplete operation to a threshold number of recommendations.

11. The device of claim 1, wherein the one or more processors are further configured to:
present, via the first, second, or third user interface, a user interface indication that allows a user to transition between the first, second, and third user interfaces; and
transition, responsive to receiving an indication that the user interface indication has been selected by the user, the first, second, or third user interface into the first, second, or third user interface.

12. The device of claim 11,
wherein the interactive log of previous inputs entered prior to the current input and the graphical representation of result data obtained responsive to the data indicative of the current input are reproduced when the one or more processors transition the first, second, or third user interface into the first, second, or third user interface.

13. The device of claim 1, wherein the graphical representation of result data includes a bar chart, a line chart, a violin chart, and a scatter chart.

14. The device of claim 13, wherein the one or more processors are configured to present the option to edit the graphical representation of result data.

15. A method of processing data indicative of a current input, the method comprising:
presenting, via a first portion of a first user interface, an interactive text box in which a user may enter the data indicative of the current input;
presenting, via a second portion of the first user interface, an interactive log of previous inputs entered prior the current input; and
presenting, via a third portion of the first user interface, a graphical representation of result data obtained responsive to the data indicative of the current input,
wherein the second and third portions of the first user interface are separately scrollable but coupled such that interactions in either the second or third portions of the first user interface synchronize the second and third portions of the first user interface; and
storing the data indicative of the current input in a memory.

16. The method of claim 15,
wherein the second portion of the first user interface is located above the first portion of the first user interface, and
wherein the first portion of the first user interface and the second portion of the first user interface are located along a right boundary of the third portion of the first user interface.

17. The method of claim 15, wherein the interactive text box automatically performs an autocomplete operation to facilitate entry of the data indicative of the current input.

18. The method of claim 17, wherein the interactive text box limits a number of recommendations suggested during the autocomplete operation to a threshold number of recommendations.

19. The method of claim 15, further comprising:
presenting, via a first portion of a second user interface, the interactive log presented by the second portion of the first user interface;
presenting, via a second portion of the second user interface, the graphical representation of result data presented by the third portion of the first user interface;
presenting, via a third portion of the second user interface, the one or more datasets; and
presenting, via a fourth portion of the second user interface, at least a portion of the multi-dimensional data included in the one or more datasets,
wherein the first and second portions of the second user interface are separately scrollable but coupled such that interactions in either the first or second portions of the second user interface synchronize the first and second portions of the second user interface.

20. The method of claim 19,
wherein the second portion of the second user interface is located above the first portion of the second user interface,
wherein the third portion of the second user interface is located above the second portion of the second user interface, and
wherein the first, second, and third portions of the second user interface are located along a right boundary of the fourth portion of the second user interface.

21. The method of claim 15, further comprising:
presenting, via a first portion of a third user interface, an interactive search bar in which a user may enter the data indicative of the current input;
presenting, via a second portion of the third user interface, an interactive log of previous inputs entered prior the current input;
presenting, via a third portion of the third user interface, a graphical representation of result data obtained responsive to the data indicative of the current input; and
presenting, via a fourth portion of the third user interface, the one or more datasets,
wherein the second, and third portions of the third user interface are separately scrollable but coupled such that interactions in either the second or third portions of the third user interface synchronize the second and third portions of the third user interface.

22. The method of claim 21,
wherein the first portion of the third user interface is located above the third portion of the third user interface,
wherein the second portion of the third user interface is located along a right boundary of the first and third portions of the third user interface, and
wherein the fourth portion of the third user interface is located along a left boundary of the first and third portions of the third user interface.

23. The method of claim 21, wherein the interactive search bar automatically performs an autocomplete operation to facilitate entry of the data indicative of the current input.

24. The method of claim 23, wherein the interactive search bar limits a number of recommendations suggested during the autocomplete operation to a threshold number of recommendations.

25. The method of claim 15, further comprising:
presenting, via the first, second, or third user interface, a user interface indication that allows a user to transition between the first, second, and third user interfaces; and
transitioning, responsive to receiving an indication that the user interface indication has been selected by the user, the first, second, or third user interface into the first, second, or third user interface.

26. The method of claim 25,
wherein the interactive log of previous inputs entered prior to the current input and the graphical representation of result data obtained responsive to the data indicative of the current input are reproduced when the one or more processors transition the first, second, or third user interface into the first, second, or third user interface.

27. The method of claim 15, wherein the graphical representation of the result data includes a bar chart, a line chart, a violin chart, and a scatter chart.

28. The method of claim 27, wherein the one or more processors are configured to present the option to edit the graphical representation of result data.

29. A non-transitory computer-readable storage medium having instructions stored thereon that, when executed, cause one or more processors to:
present, via a first portion of a first user interface, an interactive text box in which a user may enter the data indicative of the current input;
present, via a second portion of the first user interface, an interactive log of previous inputs entered prior the current input; and
present, via a third portion of the first user interface, a graphical representation of result data obtained responsive to the data indicative of the current input,
wherein the second and third portions of the first user interface are separately scrollable but coupled such that interactions in either the second or third portions of the first user interface synchronize the second and third portions of the first user interface; and
store the data indicative of the current input in a memory.

30. The non-transitory computer-readable storage medium of claim 29, wherein the one or more processors are further configured to:
present, via a first portion of a second user interface, the interactive log presented by the second portion of the first user interface;
present, via a second portion of the second user interface, the graphical representation of result data presented by the third portion of the first user interface;
present, via a third portion of the second user interface, the one or more datasets; and
present, via a fourth portion of the second user interface, at least a portion of the multi-dimensional data included in the one or more datasets,
wherein the first and second portions of the second user interface are separately scrollable but coupled such that interactions in either the first or second portions of the second user interface synchronize the first and second portions of the second user interface.

31. The non-transitory computer-readable storage medium of claim 29, wherein the one or more processors are further configured to:
present, via a first portion of a third user interface, an interactive search bar in which a user may enter the data indicative of the current input;
present, via a second portion of the third user interface, an interactive log of previous inputs entered prior the current input;
present, via a third portion of the third user interface, a graphical representation of result data obtained responsive to the data indicative of the current input; and
present, via a fourth portion of the third user interface, the one or more datasets,
wherein the second, and third portions of the third user interface are separately scrollable but coupled such that interactions in either the second or third portions of the third user interface synchronize the second and third portions of the third user interface.
